(19) United States
(12) Patent Application Publication
(10) Pub. No.: US 2015/0318532 A1
(43) Pub. Date: Nov. 5, 2015

(54) BIFUNCTIONAL SEPARATORS FOR LITHIUM-SULFUR BATTERIES

(71) Applicant: BOARD OF REGENTS, THE UNIVERSITY OF TEXAS SYSTEM, Austin, TX (US)

(72) Inventors: Arumugam Manthiram, Austin, TX (US); Sheng-Heng Chung, Austin, TX (US)

(21) Appl. No.: 14/704,446

(22) Filed: May 5, 2015

Related U.S. Application Data
(60) Provisional application No. 61/988,656, filed on May 5, 2014.
(60) Provisional application No. 62/037,836, filed on Aug. 15, 2014.

(51) Int. Cl. H01M 2/16; H01M 4/38; H01M 10/052; H01M 4/36; H01M 4/134

(52) U.S. Cl. CPC H01M 2/1686; H01M 2/1673; H01M 2/1633; H01M 2/166; H01M 4/36; H01M 4/134; H01M 10/052; H01M 4/382

(57) ABSTRACT

The present disclosure relates to a lithium-sulfur rechargeable battery containing a lithium-containing anode, a sulfur-containing cathode, and a bifunctional separator having a microporous, conductive layer facing the cathode of the battery. The bifunctional separator can inhibit polysulfide diffusion and improve sulfur cathode material reutilization to improve cell cycling stability and discharge capacity.

### PRIORITY

This application claims priority to U.S. Provisional Patent Application No. 61/988,656, filed May 5, 2014, and also claims priority to U.S. Provisional Patent Application No. 62/037,836, filed Aug. 15, 2014, the contents of which are hereby incorporated by reference in its entirety.

### STATEMENT OF GOVERNMENT INTEREST

This invention was made with government support under Grant no. DE-SC0005397 awarded by the Department of Energy. The government has certain rights in the invention.

### TECHNICAL FIELD

The current disclosure relates to improved separators for Li—S batteries.

### BACKGROUND

### Basic Principles of Batteries and Electrochemical Cells

Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode or cathode and the negative electrode or anode, an insulator separating the electrodes so the battery does not short out, and an electrolyte that chemically connects the electrodes.

In operation the secondary battery exchanges chemical energy and electrical energy. During discharge of the battery, electrons, which have a negative charge, leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge leaves the anode and enters the electrolyte and then a positive ion leaves the electrolyte and enters the cathode. In order for this ion movement to work, typically the same type of ion leaves the anode and joins the cathode. Additionally, the electrolyte typically also contains this same type of ion.

In order to recharge the battery, the same process happens in reverse. By supplying energy to the cell, electrons are induced to leave the cathode and join the anode. At the same time a positive ion, such as Li⁺, leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries, it forms a coating on the metal backing.

Unless additional materials are specified, batteries as described herein include systems that are merely electrochemical cells as well as more complex systems.

Several important criteria for rechargeable batteries include energy density, power density, rate capability, cycle life, cost, and safety. The current lithium-ion battery technology based on insertion compound cathodes and anodes is limited in energy density. This technology also suffers from safety concerns arising from the chemical instability of oxide cathodes under conditions of overcharge and it frequently requires the use of expensive transition metals. Accordingly, there is immense interest to develop alternate cathode materials for lithium-ion batteries.

Sulfur has been considered as one such alternative cathode material.

### Lithium-Sulfur Batteries

Lithium-sulfur (Li—S) batteries are a particular type of rechargeable battery. Unlike the current lithium-ion batteries in which the ion actually moves into and out of a crystal lattice, the ion in lithium-sulfur batteries reacts with sulfur in the cathode to produce a discharge product with different crystal structure. In most Li—S batteries, the anode is lithium metal (Li or Li⁰). In operation, lithium leaves the metal as lithium ions (Li⁺) and enters the electrolyte when the battery is discharging. When the battery is recharged, lithium ions (Li⁺) leave the cathode and plate out on the lithium metal anode as lithium metal (Li). At the cathode, during discharge, particles of elemental sulfur (S₈) react with the lithium ion (Li⁺) to form Li₂S. When the battery is recharged, lithium ions (Li⁺) leave the cathode, allowing to revert to elemental sulfur (S₈).

Sulfur is an attractive cathode candidate as compared to traditional lithium-ion battery cathodes because it offers an order of magnitude higher theoretical capacity (1672 mA h g⁻¹) than the currently employed cathodes (<200 mA h g⁻¹) and operates at a safer voltage range (1.5-2.8 V). This high theoretical capacity is due to the ability of sulfur to accept two electrons (e) per atom. In addition, sulfur is inexpensive and environmentally benign.

However, the practical applicability of Li—S batteries is presently limited by their poor cycle stability. The discharge of sulfur cathodes involves the formation of intermediate polysulfide ions, which dissolve easily in the liquid electrolyte that is currently used in Li—S batteries during the charge-discharge process and result in an irreversible loss of active material during cycling. The high-order polysulfides (Li₂Sₓ, 4≦x≦8) produced during the initial stage of the discharge process are soluble in the electrolyte and move toward the lithium metal anode, where they are reduced to lower-order polysulfides. Moreover, solubility of these high-order polysulfides in the liquid electrolytes and agglomeration of the nonconductive low-order sulfides (i.e., Li₂S₂ and Li₂S) result in poor capacity retention and low Coulombic efficiency. In addition, shuttling of these high-order polysulfides between the cathode and anode during charging, which involves parasitic reactions with the lithium anode and re-oxidation at the cathode, is another challenge. This process results in irreversible capacity loss and causes the build-up of a thick, irreversible Li₂S barrier on the electrodes during prolonged cycling, which is electrochemically inaccessible.

Recent improvements in cathode design, such as the implementation of conductive microporous materials to encapsulate sulfur within the cathode and suppress polysulfide shuttling, have produced Li—S batteries having high performance. Such improvements, however, are associated with limited sulfur content (and thus cathode capacity and energy density) and cycle time. Additionally, such cathode designs require unconventional fabrication techniques and additional free-standing components. Such modified cathode designs may therefore be limited in scalability and practical application.

Accordingly, a need exists for Li—S battery components that reduce polysulfide shuttling and improve discharge capacity and cyclability that are also comparatively simple to manufacture. Ideally, such component would replace an existing component of Li—S batteries, with readily available, environmentally benign materials, and would be readily scalable.

### SUMMARY

According to the present disclosure, improved Li—S battery separators are provided having readily available, environmentally benign components and providing at least one of improved discharge capacity, increased cycling stability, reduced self-discharge, and improved static stability.

In one aspect, the present disclosure relates to a Li—S rechargeable battery having a bifunctional separator comprising an electrically insulating layer and a layer of conductive, microporous carbon, the layer of conductive, microporous carbon facing the sulfur-containing cathode of the cell. The conductive, microporous carbon layer can inhibit the diffusion of polysulfides from the cathode to the anode, surface-catalyze reactivation of entrapped polysulfides, and function as an upper current collector, thereby enhancing cycling stability and cathode sulfur utilization and reducing capacity fade and static discharge.

The following abbreviations are commonly used throughout the specification:

Li⁺—lithium ion
Li or Li⁰—elemental or metallic lithium or lithium metal
S—sulfur
Li—S—lithium-sulfur
Li₂S—lithium sulfide
LiCF₃SO₃—lithium trifluoromethanesulfonate
MWCNT—multi-walled carbon nanotube
OCV—open circuit voltage
DME—1,2-dimethoxyethane
DOL—1,3-dioxolane
SEM—scanning electron microscope
EDX—energy dispersive X-ray
EIS—electrochemical impedance spectroscopy

### BRIEF DESCRIPTION OF THE DRAWINGS

A more complete understanding of the present embodiments and advantages thereof may be acquired by referring to the following description taken in conjunction with the accompanying drawings, which relate to embodiments of the present disclosure. The current specification contains color drawings. Copies of these drawings may be obtained from the USPTO.

FIG. 1A is a schematic illustration of a Li—S battery in accordance with certain embodiments of the present disclosure.

FIG. 1B is a schematic illustration of a bifunctional separator and its inhibition of polysulfide diffusion in accordance with certain embodiments of the present disclosure.

FIG. 1C is a schematic illustration of a Li—S battery containing a conventional separator.

FIG. 1D is a schematic illustration of polysulfide diffusion through a conventional separator.

FIG. 1E is a series of photographs of a bifunctional separator having a carbon powder coating layer in accordance with certain embodiments of the present disclosure. The bifunctional separator recovers its flat shape after rolling and crumpling.

FIG. 2A is an SEM micrograph at 5000× magnification of the cathode-facing surface of a carbon coating layer of a bifunctional separator prior to cycling.

FIG. 2B is an SEM micrograph at 5000× magnification of the cathode-facing surface of a carbon coating layer of a bifunctional separator after 200 cycles at a cycling rate of C/5, with adjacent micrographs showing corresponding EDX elemental mapping signals for sulfur (top, red) and carbon (bottom, green)

FIG. 2C is an SEM micrograph at 20000× magnification of the cathode-facing surface of a carbon coating layer of a bifunctional separator after 200 cycles at a cycling rate of C/5 with adjacent micrographs showing corresponding EDX elemental mapping signals for sulfur (top, red) and carbon (bottom, green). Obstructed active cathode material is indicated by dashed white annotations.

FIG. 3A is an SEM micrograph at 2500× magnification of a cross-section of the cathode side of an Li—S battery having a bifunctional separator with a carbon coating after 200 cycles at a cycling rate of C/5. The insulative polypropylene Celgard layer was removed prior to imaging.

FIG. 3B provides corresponding EDX elemental mapping signals for sulfur (red), carbon (green), fluorine (violet), aluminum (blue), and oxygen (cyan), individually and superimposed on the SEM micrograph (top left).

FIG. 4A is an SEM micrograph at 10000× magnification of the insulative layer-facing surface of the carbon coating layer of a bifunctional separator after 200 cycles at a cycling rate of C/5, with a high magnification inset region at 20000× magnification].

FIG. 4B provides corresponding EDX mapping signals for sulfur (red), carbon (green), fluorine (violet), and oxygen (cyan), individually and superimposed on the SEM micrograph (top left).

FIG. 5 provides EIS spectrum plots for cycles 0, 1, 2, 5, 10, and 20 of a cell having a conventional Celgard separator and a cell having a bifunctional carbon-coated separator (inset).

FIG. 6A provides discharge/charge curves for cycles 1-10, 15, and 20 for a Li—S battery containing a bifunctional separator cycled at a rate of C/5, with annotations to indicate upper (Q_{H}) and lower (Q_{L}) plateau discharge capacities.

FIG. 6B provides discharge/charge curves for cycles 1-10 and 15 for a Li—S battery containing a conventional Celgard® separator cycled at a rate of C/5, with annotations to indicate upper (Q_{H}) and lower (Q_{L}) plateau discharge capacities.

FIG. 6C is a plot of upper plateau discharge capacity versus cycle number of cells containing a bifunctional separator at cycling rates of 2C, 1C, C/2, and C/5 or containing a conventional Celgard separator at a cycling rate of C/5.

FIG. 6D provides cyclic voltammograms of a Li—S battery containing a bifunctional separator for cycles 1-20 at a scanning rate of 0.1 mV s⁻¹.

FIG. 7A provides discharge/charge curves for a Li—S battery containing a bifunctional separator for cycles 1-10, 15, and 20 at a cycling rate of C/2.

FIG. 7B provides discharge/charge curves for a Li—S battery containing a bifunctional separator for cycles 1-10, 15, and 20 at a cycling rate of 1C.

FIG. 7C provides discharge/charge curves for a Li—S battery containing a bifunctional separator for cycles 1-10, 15, and 20 at a cycling rate of 2C.

FIG. 8A provides plots of discharge capacity over cycles 1-50 for Li—S batteries containing a bifunctional separator at cycling rates of 2C, 1C, C/2, and C/5 or containing a conventional Celgard separator at a cycling rate of C/5.

FIG. 8B provides plots of Coulombic efficiency and discharge capacity over cycles 1-200 for Li—S batteries containing a bifunctional separator at cycling rates of 2C, 1C, C/2, and C/5.

FIG. 8C provides initial discharge capacities of Li—S batteries containing a bifunctional separator or a conventional separator after resting for 30 minutes, 1 month, 2 months, or 3 months after battery assembly at a cycling rate of C/5.

FIG. 8D provides initial discharge curves of Li—S batteries containing a bifunctional separator after resting for 30 minutes, 1 month, 2 months, or 3 months after battery assembly at a cycling rate of C/5, with annotations to indicate the original upper plateau discharge capacity (Q_{H°}) and upper plateau discharge capacities (Q_{H}) with different storage times.

FIG. 8E provides initial discharge curves of Li—S batteries containing a conventional Celgard separator after resting for 30 minutes, 1 month, 2 months, or 3 months after battery assembly at a cycling rate of C/5, with annotations to indicate the original upper plateau discharge capacity (Q_{H°}) and upper plateau discharge capacities (Q_{H}) with different storage times.

FIG. 9A provides plots of discharge capacity for cycles 1-10 of Li—S batteries containing a conventional Celgard separator or a bifunctional separator having a carbon coating layer after resting for 30 minutes after assembly at a cycling rate of C/5.

FIG. 9B provides plots of discharge capacity for cycles 1-10 of Li—S batteries containing a conventional Celgard separator or a bifunctional separator having a carbon coating layer after resting for 1 month after assembly at a cycling rate of C/5.

FIG. 9C provides plots of discharge capacity for cycles 1-10 of Li—S batteries containing a conventional Celgard separator or a bifunctional separator having a carbon coating layer after resting for 2 months after assembly at a cycling rate of C/5.

FIG. 9D provides plots of discharge capacity for cycles 1-10 of Li—S batteries containing a conventional Celgard separator or a bifunctional separator having a carbon coating layer after resting for 3 months after assembly at a cycling rate of C/5

FIG. 10A is an SEM micrograph at 2000× magnification of the surface of the cathode of an uncycled Li—S battery having a conventional Celgard separator after resting for one month after assembly, with regions exhibiting loss of active cathode material annotated with dashed red circling and regions exhibiting insulating precipitates annotated with dashed white circling.

FIG. 10B is an SEM micrograph of the surface of the cathode of an uncycled Li—S battery having a conventional Celgard separator after resting for one month after assembly.

FIG. 11A is an SEM micrograph of the surface of the cathode of an uncycled Li—S battery having a bifunctional separator after resting for one month after assembly.

FIG. 11B is a higher magnification SEM micrograph of the surface of the cathode of an uncycled Li—S battery having a bifunctional separator after resting for one month after assembly.

FIG. 12 provides plots of the natural logarithm (1n) of upper plateau discharge capacity (Q_{H}) divided by the original upper plateau discharge capacity (Q_{H°}) as a function of resting time for cells containing bifunctional or conventional Celgard separators. The inset table provides the observed self-discharge constants (K_{S}) for the cells.

FIG. 13 provides plots of Coulombic efficiency and discharge capacity for Li—S batteries having a bifunctional separator with a carbon coating layer dried at 50° C. in an air oven for 24 hours or air-dried for 30 minutes.

FIG. 14 is a schematic illustration of a method of forming a bifunctional separator having a MWCNT coating layer according to certain embodiments of the present disclosure.

FIGS. 15A-15C are a series of photographs of a bifunctional separator having a MWCNT coating layer in accordance with certain embodiments of the present disclosure, wherein:

FIG. 15A depicts a freshly-prepared bifunctional separator having a MWCNT coating layer;

FIG. 15B depicts the same bifunctional separator during mechanical folding; and

FIG. 15C depicts the same bifunctional separator after mechanical folding having recovered its initial shape.

FIG. 16A is schematic illustration of a Li—S battery having a bifunctional separator with a MWCNT coating layer according to certain embodiments of the present disclosure, with annotations to indicate inhibition of polysulfide diffusion to the anode side of the cell by the MWCNT coating layer and to indicate stable electrochemical environment of the cell by the MWCNT coating layer.

FIG. 16B is an SEM micrograph at 10000× magnification of the cathode-facing surface of the MWCNT coating layer of the bifunctional separator from an uncycled Li—S cell with a high-magnification inset at 100000× magnification and corresponding EDX elemental mapping signals for sulfur (red) and carbon (green).

FIG. 16C is an SEM micrograph at 10000× magnification of the cathode-facing surface of the MWCNT coating layer of the bifunctional separator from a Li—S cell after cycling for 150 cycles at a cycling rate of C/5, and corresponding EDX elemental mapping signals for sulfur (red) and carbon (green).

FIG. 16D is an SEM micrograph at 10000× magnification of the insulative layer-facing surface of the MWCNT coating layer of the bifunctional separator from a Li—S batteries after cycling for 150 cycles at a cycling rate of C/5, and corresponding EDX elemental mapping signals for sulfur (red) and carbon (green).

FIG. 17A provides discharge/charge curves for cycles 1, 2, 4, 6, 8, 10, 12, 14, 16, 18, and 20, of Li—S batteries containing a bifunctional separator with a MWCNT coating layer at a cycling rate of C/5, with annotations to indicate upper (Q_{H}) and lower (Q_{L}) plateau discharge capacities.

FIG. 17B provides cyclic voltammograms for cycles 1, 2, 4, 6, 8, 10, 12, 14, 16, 18, and 20, of Li—S batteries containing a bifunctional separator with a MWCNT coating layer at a scanning rate of 0.1 mV s⁻¹.

FIG. 17C provides plots of upper plateau discharge capacities for Li—S batteries containing a bifunctional separator with a MWCNT coating layer at a cycling rate of C/5, C/2, and 1C for cycles 1, 2, 4, 6, 8, 10, 12, 14, 16, 18, and 20 and Li—S batteries containing a conventional Celgard separator at a cycling rate of C/5 for cycles 1, 2, 4, and 6.

FIG. 18 provides EIS spectrum plots for Li—S batteries having a conventional Celgard separator or a bifunctional separator with a MWCNT coating layer (inset).

FIG. 19 provides discharge/charge curves for cycles 1, 2, 4, 6, 8, 10, 12, 14, 16, 18, and 20, of Li—S batteries containing a bifunctional separator with a MWCNT coating layer at a cycling rate of C/2, with annotations to indicate upper (Q_{H}) and lower (Q_{L}) plateau discharge capacities.

FIG. 20 provides discharge/charge curves for cycles 1, 2, 4, 6, 8, 10, 12, 14, 16, 18, and 20, of Li—S batteries containing a bifunctional separator with a MWCNT coating layer at a cycling rate of 1C, with annotations to indicate upper (Q_{H}) and lower (Q_{L}) plateau discharge capacities.

FIG. 21A provides plots of discharge capacity and Coulombic efficiency over cycles 1-150 for Li—S batteries containing a bifunctional separator having a MWCNT coating layer, or over cycles 1-100 for Li—S batteries containing a conventional Celgard separator, at cycling rates of 1C, C/2, and C/5.

FIG. 21B provides plots of discharge capacity and Coulombic efficiency over cycles 1-300 for Li—S batteries containing a bifunctional separator having a MWCNT coating layer, or over cycles 1-100 for Li—S batteries containing a conventional Celgard separator, at a cycling rate of 1C

FIG. 22 is an SEM micrograph at 2000× magnification of the surface of a sulfur cathode of a Li—S battery containing a bifunctional separator having an MWCNT coating layer after 150 cycles at a cycling rate of C/5.

FIGS. 23A-23D are a series of photographs of a bifunctional separator having a polymer-coated microporous carbon layer in accordance with certain embodiments of the present disclosure, wherein:

FIG. 23A depicts a freshly prepared bifunctional separator having a polymer-coated microporous carbon layer;

FIG. 23B depicts the same bifunctional separator during mechanical folding;

FIG. 23C depicts the same bifunctional separator after mechanical folding having recovered its initial shape; and

FIG. 23D depicts a similar bifunctional separator after cycling.

FIG. 24A is schematic illustration of a Li—S battery having a bifunctional separator with a polymer-coated microporous carbon layer according to certain embodiments of the present disclosure.

FIG. 24B is an SEM micrograph of the cathode-facing surface of the polymer-coated microporous carbon layer of the bifunctional separator from an uncycled Li—S cell with corresponding EDX elemental mapping signals for sulfur (red) and carbon (green).

FIG. 24C is an SEM micrograph of the cathode-facing surface of the polymer-coated microporous carbon layer of the bifunctional separator from a cycled Li—S cell with corresponding EDX elemental mapping signals for sulfur (red) and carbon (green).

FIG. 24D is an SEM micrograph of a cross-section of the cathode side of an Li—S battery having a bifunctional separator with a polymer-coated microporous carbon layer after cycling.

FIG. 24E is an SEM micrograph of the anode-facing surface of the Celgard layer of the bifunctional separator with a polymer-coated microporous carbon layer after cycling.

FIG. 24F is an SEM micrograph of the cathode-facing surface of the bifunctional separator with a polymer-coated microporous layer from a cycled cell after partial scraping away of the polymer-coated microporous carbon layer coating from the surface of the Celgard layer.

FIG. 25A is a low-magnification SEM micrograph of the carbon nanoparticles of the surface of the polymer-coated microporous carbon layer of the bifunctional separator from an uncycled Li—S cell, with corresponding elemental mapping.

FIG. 25B is a high-magnification SEM micrograph of the carbon nanoparticles of the surface of the polymer-coated microporous carbon layer of the bifunctional separator from an uncycled Li—S cell, with corresponding elemental mapping.

FIG. 26A is a surface area analysis of the polymer-coated microporous carbon layer of the bifunctional separator from cycled and uncycled Li—S cells as determined by isotherms.

FIG. 26B is a pore size distribution analysis of the polymer-coated microporous carbon layer of the bifunctional separator from cycled and uncycled Li—S cells as determined by the Barrett-Joyer-Halenda method.

FIG. 26C is a pore size distribution analysis of the polymer-coated microporous carbon layer of the bifunctional separator from cycled and uncycled Li—S cells as determined by the Horvath-Kawazoe and density functional theory methods.

FIG. 27 is an SEM micrograph of the carbon nanoparticles of the surface of the polymer-coated microporous carbon layer of the bifunctional separator from an uncycled Li—S cell, with corresponding elemental mapping.

FIG. 28 is an SEM micrograph of the carbon nanoparticles of the surface of the polymer-coated microporous carbon layer of the bifunctional separator from a cycled Li—S cell, with corresponding elemental mapping.

FIG. 29A is an SEM micrograph, with corresponding elemental mapping, of a pure sulfur cathode from an uncycled Li—S cell containing a bifunctional separator having a polymer-coated microporous carbon layer.

FIG. 29B is an SEM micrograph, with corresponding elemental mapping, of a pure sulfur cathode from a cycled Li—S cell containing a bifunctional separator having a polymer-coated microporous carbon layer.

FIG. 30A provides discharge/charge curves for cycles 1-5, 10, 15, and 20 of an Li—S battery containing a bifunctional separator having a polymer-coated microporous carbon coating layer at a cycling rate of C/5, with annotations to indicate upper (Q_{H}) and lower (Q_{L}) plateau discharge capacities.

FIG. 30B provides cyclic voltammograms for cycles 1, 2, 5, 10, 15, and 20 of Li—S batteries containing a bifunctional separator having a polymer-coated microporous carbon coating layer at a scanning rate of 0.1 mV s⁻¹.

FIG. 30C provides plots of discharge capacity and Coulombic efficiency om Li—S batteries containing a bifunctional separator having a polymer-coated microporous carbon layer and for Li—S batteries containing a conventional Celgard separator, at cycling rates of 1C, C/2, and C/5 as indicated.

### DETAILED DESCRIPTION

One aspect of the current disclosure provides a separator for an electrochemical cell, the separator comprising an electrically insulative layer and a layer of conductive, microporous material. The separator functions in the normal manner by allowing ion transit while electrically insulating the cell's cathode from the anode, but in addition, it may also entrap polysilfide materials in that are reactivated by conduction of electrons by the conductive, microporous material during cell cycling. In accordance with the present disclosure, the layer of conductive, microporous material can be composed of any conductive, microporous, nometallic material that is chemically inert in a given cell. By way of example and not limitation, the conductive, microporous material can be composed of carbon, allotropes thereof, oxides thereof, and combinations thereof. In certain embodiments, the conductive, microporous material is composed of carbon. In certain embodiments, the carbon is carbon powder. In certain embodiments, the carbon is carbon nanotubes. In certain embodiments, the conductive, microporous material is polymer-coated. In certain embodiments, the electrochemical cell is a rechargeable Li—S battery.

### Li—S Batteries

In certain non-limiting embodiments, the current disclosure provides an electrochemical cell comprising an anode, the anode comprising lithium; a cathode comprising a material comprising electroactive sulfur; a bifunctional separator, the bifunctional separator having an electrically insulating layer separating the anode and cathode, the bifunctional separator having a second layer comprising conductive, microporous material disposed on the cathode side of the electrically insulating layer; and an electrolyte.

a) Anode comprising Lithium

In certain embodiments, the battery contains an anode comprising lithium. The anode can be made of any material in which lithium ions (Li⁺) can intercalate or be deposited. Suitable anode materials include, without limitation, lithium metal (Li or Li⁰ anode), such as lithium foil and lithium deposited on a substrate, lithium alloys, including silicon-lithium alloys, tin-lithium alloys, aluminum-lithium alloys, and magnesium-lithium alloys, and lithium intercalation materials, including lithiated carbon, lithiated tin, and lithiated silicon.

The anode can have any structure suitable for use in a given electrochemical cell. The anode may be arranged in a single-layer configuration or a multi-layer configuration. Suitable anode configurations include, for example, the multi-layer configurations disclosed in U.S. Pat. No. 8,105,717 to Skotheim et al., hereby incorporated herein by reference in its entirety.

### b) Cathodes and Catholytes

In certain embodiments, the cathode comprises a material containing electroactive sulfur. By way of example and not limitation, the cathode can comprise elemental sulfur, including, without limitation, crystalline sulfur, amorphous sulfur, precipitated sulfur, and melt-solidified sulfur, sulfides, polysulfides, sulfur oxides, organic materials comprising sulfur, and combinations thereof. Where the cathode comprises elemental sulfur, the elemental sulfur can be coated with a conductive material, such as a conductive carbon.

The cathode can have any configuration suitable for use in a given electrochemical cell. For example, the cathode can be of single-layer construction, such as elemental sulfur deposited on a current collector, or multi-layer configuration.

Additionally or alternatively, certain embodiments in accordance with the present disclosure can contain a conductive cathode and a polysulfide catholyte. A “catholyte” as used herein, refers to a battery component that both functions as an electrolyte and contributes to the cathode. In such embodiments, the cathode can comprise a conductive electrode, such as a carbon nanofiber electrode or a microporous carbon electrode. By way of example and not limitation, suitable catholytes and cathodes are disclosed in U.S. Patent No. 2013/0141050 to Visco et al. and U.S. patent application Ser. No. 13/793,418 to Manthiram et al., filed Mar. 11, 2013, both of which are hereby incorporated by reference in their entireties.

The polysulfide catholyte can contain a polysulfide with a nominal molecular formula of Li₂S₆. The polysulfide can, in some embodiments, contain components with the formula Li₂Sₓ, where 4≦x≦8. In a more specific embodiment, the polysulfide can be present in an amount with a sulfur concentration of 1-8 M, more specifically, 1-5 M, even more specifically 1-2 M. For example, it can be present in a 1 M amount, a 1.5 M amount, or a 2 M amount. The catholyte can also contain a material in which the polysulfide is dissolved. For example, and as discussed below, the catholyte can also contain LiCF₃SO₃, LiTFSI, LiNO₃, dimethoxy ethane (DME), 1,3-dioxolane (DOL), tetraglyme, other lithium salt, other ether-based solvents, and any combinations thereof.”

### c) Electrolytes

The electrolyte can be any electrolyte suitable for use in an electrochemical cell and suitable for use with the electrolyte additives disclosed herein. In preferred embodiments, the electrolyte is a nonaqueous liquid electrolyte and is in fluid communication with the conductive, microporous material layer of the separator. The nonaqueous electrolyte can be a nonionic liquid or an organic liquid. In certain embodiments, the liquid electrolyte includes one or more organic solvents. Suitable organic solvents include, without limitation, acyclic ethers such as diethyl ether, dipropyl ether, dibutyl ether, dimethoxymethane, trimethoxymethane, dimethoxyethane, diethoxyethane, 1,2-dimethoxypropane, and 1,3-dimethoxypropane, cyclic ethers such as tetrahydrofuran, tetrahydropyran, 2-methyltetrahydrofuran, 1,4-dioxane, 1,3-dioxolane, and trioxane, polyethers such as diethylene glycol dimethyl ether (diglyme), triethylene glycol dimethyl ether (triglyme), tetraethylene glycol dimethyl ether (tetraglyme), higher glymes, ethylene glycol divinylether, diethylene glycol divinylether, triethylene glycol divinylether, dipropylene glycol dimethyl ether, and butylene glycol ethers, and sulfones such as sulfolane, 3-methyl sulfolane, and 3-sulfolene. In certain embodiments, the liquid electrolyte comprises a mixture of organic solvents. Suitable organic solvent mixtures include, without limitation, those disclosed in U.S. Pat. No. 6,225,002 to Nimon et al., hereby incorporated herein by reference in its entirety.

In certain embodiments, the electrolyte includes one or more ionic electrolyte salts. Preferably, the one or more ionic electrolyte salts includes one or more ionic lithium electrolyte salt. Suitable ionic lithium electrolyte salts include, without limitation, LiSCN, LiBr, LiI, LiClO4, LiAsF₆, LiCF₃SO₃, LiSO₃CH₃, LiBF₄, LiB(Ph)₄, LiPF₆, LiC(SO₂CF₃)₃, and LiN(SO₂CF₃)₂.

In certain embodiments, the electrolyte includes one or more additives to improve cycling stability and anode electrolyte interface stability. Suitable additives include, by way of example and not limitation, lithium nitrate and related additives as disclosed in U.S. Pat. No. 7,553,590 to Michaylek.

### Bifunctional Separators

In accordance with the present disclosure, a bifunctional separator is provided. The bifunctional separator includes an electrically insulative layer and a layer comprising a conductive, microporous material. The bifunctional separator can permit ion transport between the anode and cathode and prevent short circuit of the cell, and can further inhibit polysulfide dissolution from the cathode to the anode and/or promote active cathode material reutilization. In this regard, the microporous, conductive material layer can function as a polysulfide “trap.”

The electrically insulative layer can be any non-conductive permeable membrane that permits ionic charge carrier transport between electrodes while preventing formation of a circuit within the cell (i.e., a short circuit). The insulative layer should also possess mechanical strength and flexibility, chemical stability in the cell environment, suitable porosity, and limited thickness. The porosity of the insulative layer is preferably about 40%. Suitable materials for the insulative layer include, by way of example and not limitation, nonwoven fibers and microporous polymers. In certain embodiments, the electrically insulative layer is a microporous polymer membrane. In certain embodiments, the electrically insulative layer is a polyolefin membrane, such as a polypropylene membrane, a polyethylene membrane, or a composite polypropylene/polyethylene membrane. In certain embodiments, the electrically insulative layer has a thickness between about 15 μm and about 30 μm. In certain embodiments, the electrically insulative layer is a polypropylene membrane. In certain embodiments, the electrically insulative layer is a Celgard® membrane. Additional suitable insulative layers include, without limitation, ceramic solid electrolyte membranes.

The conductive, microporous material layer can be deposited directly onto the electrically insulative layer. Alternatively, one surface of the electrically insulative layer can be coated with the layer of conductive, microporous material. In certain embodiments, the conductive, microporous material layer can be chemically grafted to the surface of the electrically insulative layer. After arrangement of the adjacent layers of the bifunctional separator, the separator can be heated in an oven to heat-set the bifunctional separator.

The conductive, microporous material can be any conductive, microporous material that is stable in the chemical environment of the cell and has a pore size that can entrap polysulfide solutes while permitting ion transit between electrodes. By way of example and not limitation, the conductive, microporous material can be carbon, allotropes thereof, oxides thereof, and combinations thereof. The conductive, microporous material is preferably lightweight and thin, with a weight less than about 0.2 mg/cm² and a thickness of between about 2 μm to about 30 μm.

By way of example and not limitation, the conductive, microporous material can be carbon powder, carbon nanotubes, and microporous graphite oxide.

In certain embodiments, the conductive, microporous material is carbon powder. The carbon powder can be composed of carbon particles having a diameter from 10 nm to 100 μm. The carbon powder can further include a binder, such as a polymeric binder. Suitable binders include polyethylene glycol and polyvinyl difluoride. For carbon powder having carbon particles with a diameter of 10 μm or greater, formation of a robust coating layer is significantly enhanced by incorporation of a binder. The carbon can be deposited as a layer onto the electrically insulative layer by conventional casting methods, such as tape casting.

In certain embodiments, the conductive, microporous material is a sheet of carbon nanotubes. The carbon nanotubes can be interwoven. The carbon nanotubes can be multi-walled carbon nanotubes (MWCNT). The carbon nanotubes can be deposited on the electrically insulative layer by vacuum filtration of a solution of carbon nanotubes. In certain embodiments, the carbon nanotubes can themselves be coated with carbon powder. Methods of forming carbon nanotube layers suitable for use as conductive, microporous material layers in accordance with the present disclosure are disclosed in U.S. patent application Ser. No. 13/793,418 to Manthiram et al., hereby incorporated herein by reference in their entireties.

In certain embodiments, the conductive, microporous material is coated in a polymeric coating. Suitable polymers for polymeric coating of the conductive, microporous material include, by way of example and not limitation, polyethylene glycol (PEG). The polymer coating can chemically bind the microporous, conductive material and improve adhesion of the microporous, conductive material to the electrically insulative layer to enhance the mechanical strength and integrity of the microporous, conductive material layer. The polymer coating can also function as a flexible “cushion” to accommodate changes in the volume of the microporous, conductive material layer due to the influx of active cathode material during cell cycling.

### Electrochemical Performance

Li—S batteries containing a bifunctional separator in accordance with the present disclosure can exhibit one or more of improved cycle stability, increased discharge capacity, and reduced self-discharge rate relative to Li—S batteries containing a conventional separator. Without limitation to theory, it is believed that the conductive, microporous layer entraps polysulfides dissolved in the electrolyte, inhibiting polysulfide diffusion to the anode region of the cell. The entrapped polysulfide material is reactivated by conduction of electrons to the polysulfide material by the conductive layer during cycling, resulting in high reutilization of the trapped active cathode material. High reutilization prevents formation of large insulating agglomerates of polysulfide material, while inhibition of shuttling of polysulfides to the anode region of the cell prevents anode degradation.

Batteries according to the present disclosure may include a separator as described above with the conductive, microporous material on the side of the separator facing the sulfur-containing electrode or the electrode at which polysulfides are formed

Batteries according to the present disclosure can have a discharge capacity of at least 1000 mA h g⁻¹ (based on mass of sulfur) at a rate of 1C. They can have a discharge capacity of at least 1100 mA h g⁻¹ (based on mass of sulfur) at a rate of C/2. They can have a discharge capacity of at least 1300 mA h g⁻¹ (based on mass of sulfur) at a rate of C/5.

Batteries according to the present disclosure may have a capacity of at least 1.0 e⁻ per sulfur atom at C/2 through C/10. More specifically, capacity may be at least 2.0 e⁻ per sulfur atom at C/10, or at least 1.5 e⁻ per sulfur atom at C/2.

Batteries according to the present disclosure may retain at least 80% of their discharge capacity over 50 cycles or even over 100 cycles when cycled between 1.8 V and 2.8 V. In more specific embodiments, they may retain at least 88% or even at least 93% of their discharge capacity over 50 cycles or even over 100 cycles when cycled between 1.8 V and 3.0 V. Batteries may retain at least 85%, at least 88%, or at least 93% of their discharge capacity over even 200 cycles if cycled in a narrow voltage window, such as 1.8 V to 2.2 V. Batteries may retain at least 60% of their discharge capacity over 200 cycles or even over 300 cycles when cycled between 1.8 V and 3.0 V.

Batteries according to the present disclosure may retain 80% or more of their discharge capacity after a rest period of up to three months.

Batteries according to the present disclosure may have a Coulombic efficiency of at least 95%.

Batteries of the present disclosure may contain contacts, a casing, or wiring. In the case of more sophisticated batteries, they may contain more complex components, such as safety devices to prevent hazards if the battery overheats, ruptures, or short circuits. Particularly complex batteries may also contain electronics, storage media, processors, software encoded on computer readable media, and other complex regulatory components.

Batteries may be in traditional forms, such as coin cells or jelly rolls, or in more complex forms such as prismatic cells. Batteries may contain more than one electrochemical cell and may contain components to connect or regulate these multiple electrochemical cells.

Batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

The details of these processes and battery components that may be formed are described above or in the following examples.

### Examples

The following examples are provided to further illustrate specific embodiments of the disclosure. They are not intended to disclose or describe each and every aspect of the disclosure in complete detail and should not be so interpreted.

Bifunctional Separators with a Carbon Powder Coating Layer

Electrochemical cells having pure sulfur cathodes and bifunctional separators with a lightweight carbon coating were constructed. Electrochemical performance of the cell was evaluated and the separators and the cathodes were characterized. The cells containing the carbon-coated separators exhibited high initial discharge capacity (1389 mA h g⁻¹) with a high reversible capacity of 828 mA h g⁻¹ after 200 cycles, with excellent static stability as evidenced by a low rate of self-discharge and high capacity retention after a three month rest period.

### Materials and Methods

### i) Carbon-Coated Bifunctional Separators

Bifunctional carbon-coated polypropylene separators were prepared by surface coating one side of each commercial polypropylene separator (Celgard 2500 monolayer polypropylene membrane) with commercial conductive carbon black powder (Super P, Timcal). A slurry of the carbon black powder was prepared by mixing the carbon black powder with isopropyl alcohol overnight. The slurry was coated onto the Celgard separator by the tape casting method to coat the slurry onto the Celgard separator using an automatic film applicator (1132N, Sheen) at traverse speed of 50 mm s⁻¹. The tape casting method is commonly used in cathode preparation, and permits facile and readily scalable application for coated separator preparation. The coated separators were then dried either for 24 hours at 50° C. in an air-oven. The coated separators were cut into circular discs and inserted into coin cells (as described below). The carbon-coated side faced the cathode of the cells. Additional carbon-coated separators were prepared by drying in air for 30 min to determine if drying condition affected battery cycling performance.

### ii) Sulfur Cathodes

A slurry of active sulfur material was prepared by mixing precipitated sulfur, Super P carbon black powder, and polyvinylidene fluoride (60%, 20%, and 20% by weight, respectively). The sulfur active material was tape-casted onto aluminum foil current collectors and dried for 24 hours at 50° C. in an air oven, followed by roll-pressing and cutting into circular discs to form the pure sulfur cathodes. The sulfur loading in the final cathode discs was 1.1 to 1.3 mg/cm².

iii) Cell Assembly

Cells were assembled as CR2032 coin cells containing a lithium anode made from lithium metal foil (99.9%) from Sigma-Aldrich (St. Louis, Mo.) cut into circular discs, as well as a pure sulfur cathode and a carbon-coated separator as described above in an argon-filled glove box. Separators and cathodes were dried in a vacuum oven for one hour at 50° C. prior to cell assembly. The electrolyte contained 1.85 M LiCF₃SO₃ salt and 0.1 M LiNO₃ co-salt in a 1:1 solvent ratio of DEM and DOL. All electrolyte materials were purchased from Acros Organics. The assembled cells were allowed to rest for 30 minutes, one month, two months, or three months at 25° C. before electrochemical cycling. Cycled carbon-coated separators and cycled and fresh sulfur cathodes were stored in an argon-filled sealed vessel prior to analysis. Cycled separators and cathodes were retrieved from cycled cells inside an argon-filled glove box.

### iv) Characterization

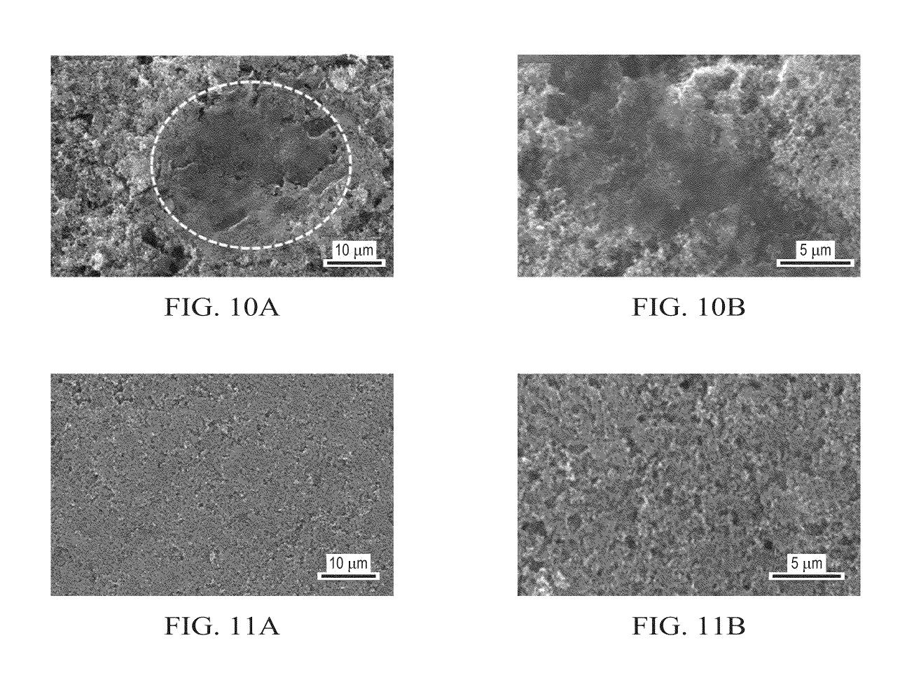

Morphology of fresh and cycled carbon-coated separators was inspected by scanning electron microscopy (‘SEM’) (JEOL JSM 5610) (used for wide-range morphological observation of the cathode after storage, as shown in FIGS. 10 and 11), and a field emission scanning electron microscope (FE-SEM) (FEI Quanta 650) (used for all other microstructural observations). Both SEMs were equipped with energy dispersive X-ray (‘EDX’) spectrometers for collection and mapping of elemental signals. Electrochemical impedance spectroscopy (‘EIS’) data were obtained with impedance analyzer (SI 1260) and electrochemical interface (SI 1287) from 1 MHz to 100 mHz with an AC voltage amplitude of 5 mV. Cyclic voltammograms (CV) were recorded with a universal potentiostat (VoltaLab PGZ 402, Radiometer Analytical) with a voltage window of 1.8-2.8 V at a scan rate of 0.1 mV s⁻¹, equivalent to a rate of C/5. Discharge/charge voltage profiles and cyclability data were collected with a programmable battery cycler (Arbin Instruments) with a voltage window of 1.8 V-2.8 V at cycling rates between C/5 to 2C. The cutoff potential of 1.8 V was selected to avoid an irreversible reduction at ˜1.6 V due to the LiNO₃ co-salt. Self-discharge behavior of the cells was investigated by measuring the initial discharge capacities of the cells after various rest times as specified.

### Characterization of the Carbon-Coated Separator

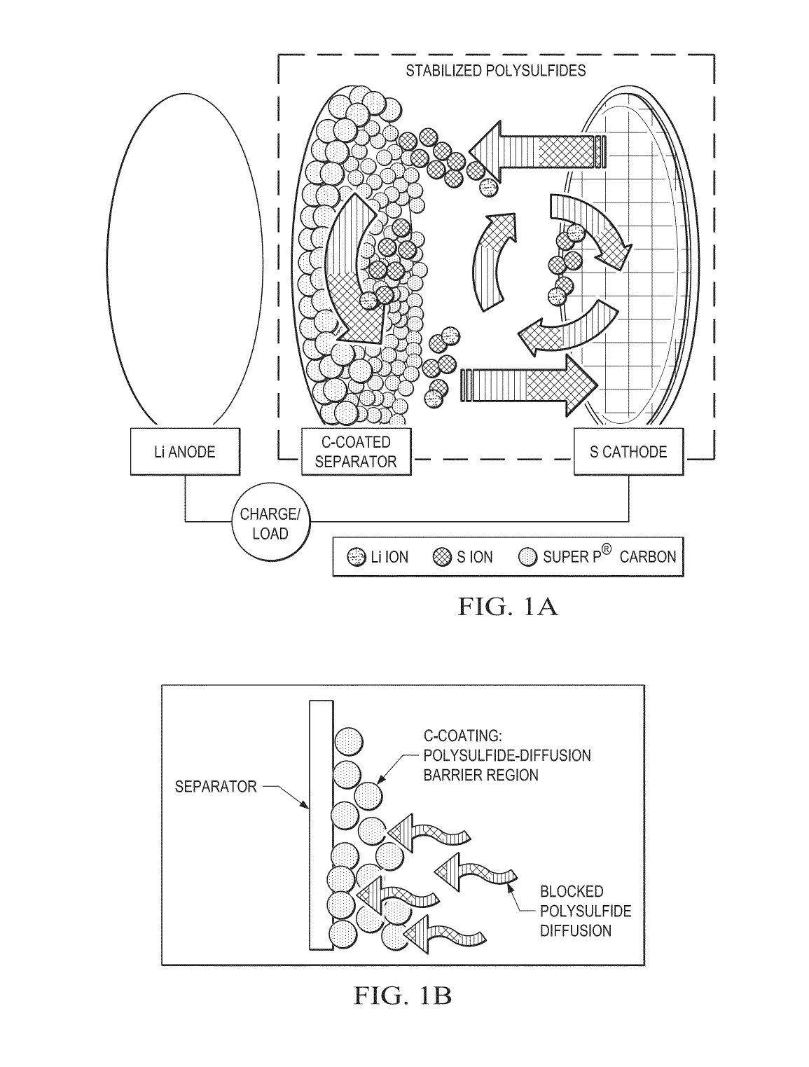

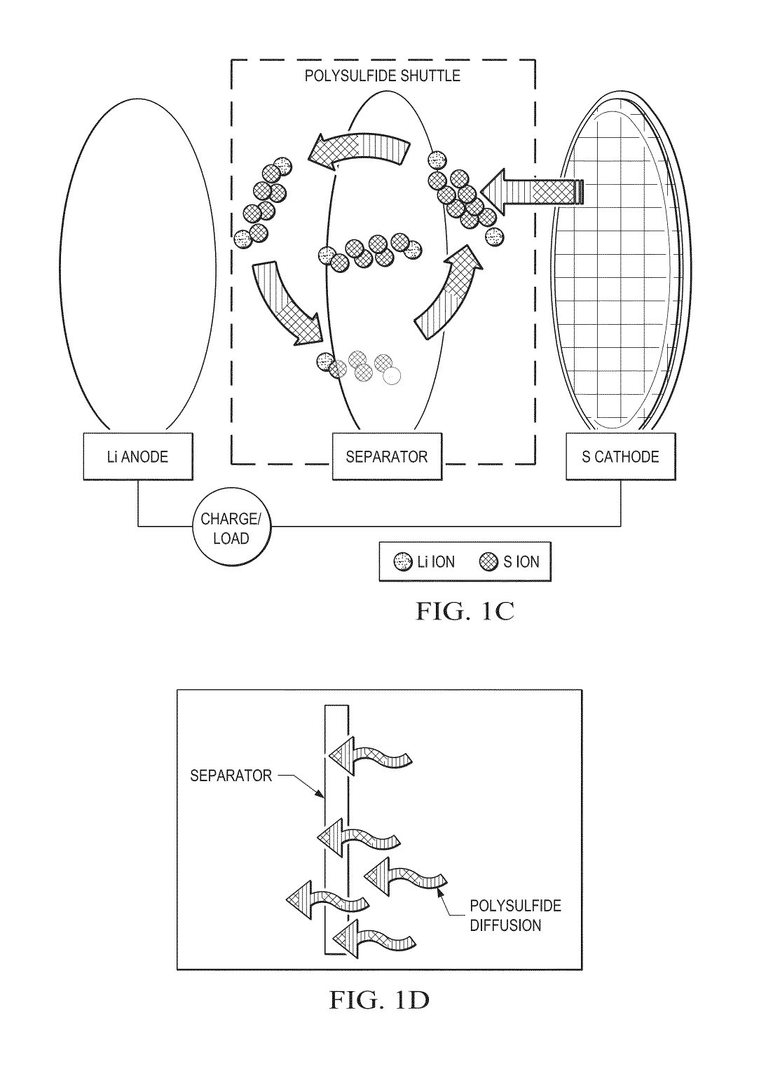

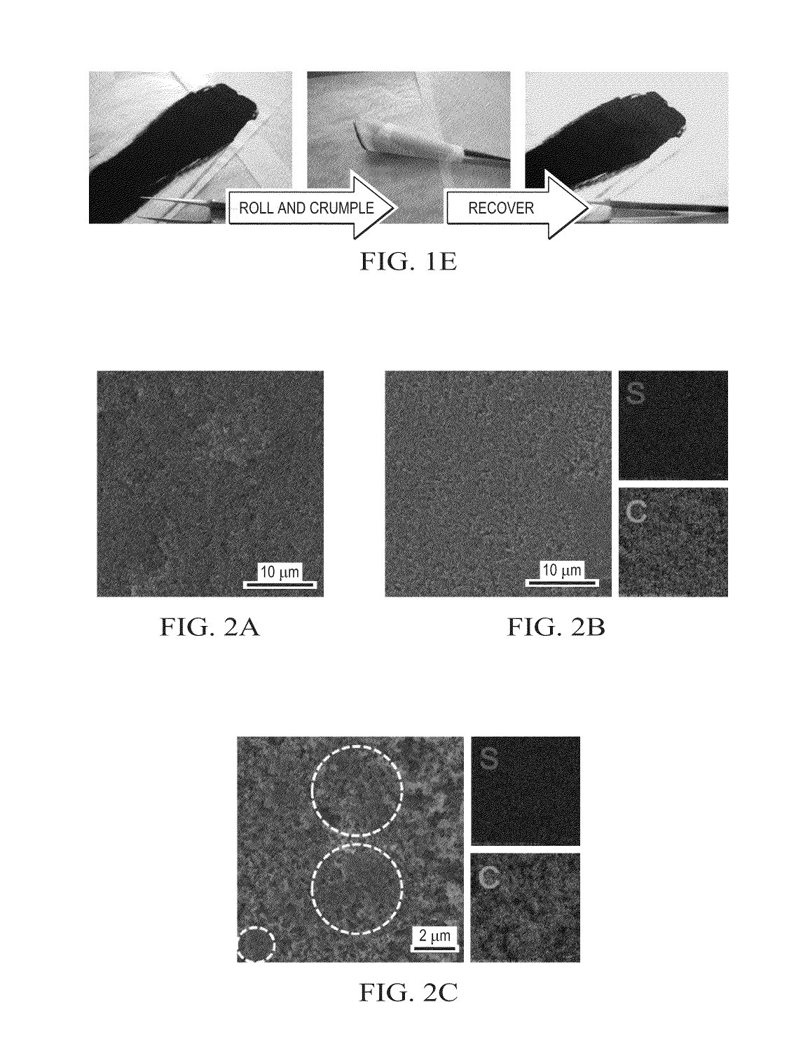

The carbon-coated separator is illustrated schematically in FIG. 1A. The carbon-coated separator consists of a lightweight conductive carbon coating on one side of a polypropylene separator. As illustrated schematically in FIG. 1B, the carbon-coated side of the separator faces the sulfur cathode and acts as a barrier to the migration of polysulfides to prevent their diffusion through the separator. The conductive carbon coating also provides electron pathways for the insulating sulfur cathode and functions as an upper current collector to accelerate electron transport. During long-term cycling, this upper current collector transports electrons into the impeded active material (i.e., the polysulfides) to reactivate it. Thus the carbon coating results in high sulfur cathode material utilization and active material reutilization. The insulating Celgard separator, however, remains highly electronically resistive.

In contrast, and as illustrated schematically in FIGS. 1C and 1D, control cells with a conventional separator exhibit extensive polysulfide diffusion and shuttling.

The carbon coating has a thickness of ˜20 μm and a weight of 0.2 mg cm⁻², much lower than the weight of the Celgard separator (1.0 mg cm⁻²). The carbon-coated separator cells therefore retain high sulfur loading of greater than 55% by weight in the cathode. As illustrated in FIG. 1E, the carbon-coated separators exhibit good flexibility and mechanical strength, permitting the separators to retain normal function during cell cycling.

### Morphological and Elemental Mapping Analyses of the Cycled Carbon-Coated Separator

FIG. 2A is an SEM micrograph of the surface of a freshly prepared, uncycled carbon-coated separator; FIGS. 2B and 2C are regular and high-magnification SEM micrographs of the surface of a carbon-coated separator after 200 cycles, with corresponding EDX elemental mapping of sulfur and carbon shown in green and red, respectively. As shown, the freshly prepared carbon-coated separator consists of microporous nanoparticle clusters uniformly attached to the polypropylene separator. As shown in the EDX insets of FIGS. 2B and 2C, sulfur-containing species are evenly distributed on the carbon coating of the separator. Active sulfur materials observed on the surface of the carbon coating are circled in FIG. 2C. No apparent dense sulfur signals are observed after 200 cycles, and elemental carbon signals remain strong.

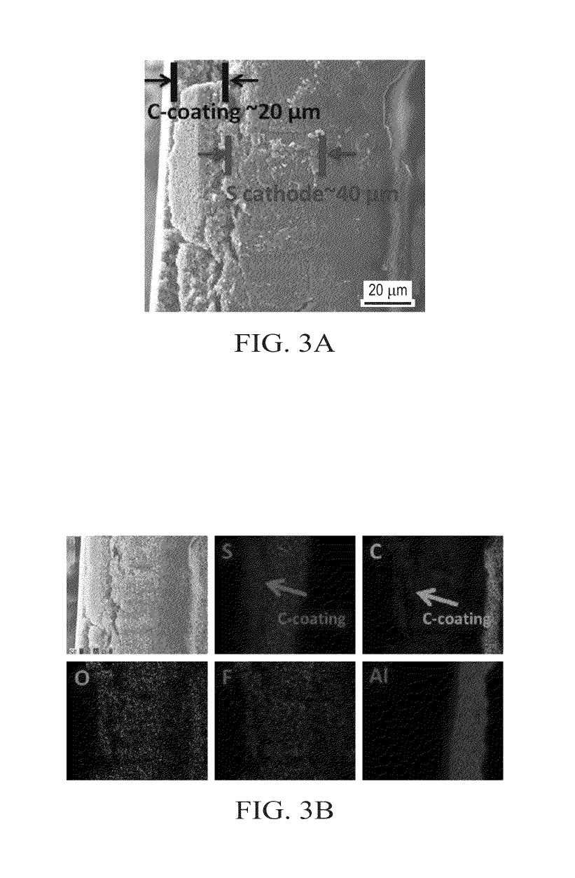

SEM and EDX mapping was also conducted on cross-sections of cells containing the carbon-coated separators after 200 cycles after careful removal of the Celgard layer to prevent charging of the scanning electron beam during SEM analysis. Corresponding micrographs and elemental mapping analysis overlays are provided in FIGS. 3A and 3B, with the Super P carbon coating having a thickness of approximately 20 um, the sulfur cathode material having a thickness of approximately 40 um, and the aluminum foil current collector shown from left to right. A sulfur concentration gap is apparent at the interface between the carbon coating and the sulfur cathode, and a sulfur concentration gradient is apparent within the carbon coating, the sulfur signal appearing stronger at the cathode side of the coating and decreasing in strength towards the separator.

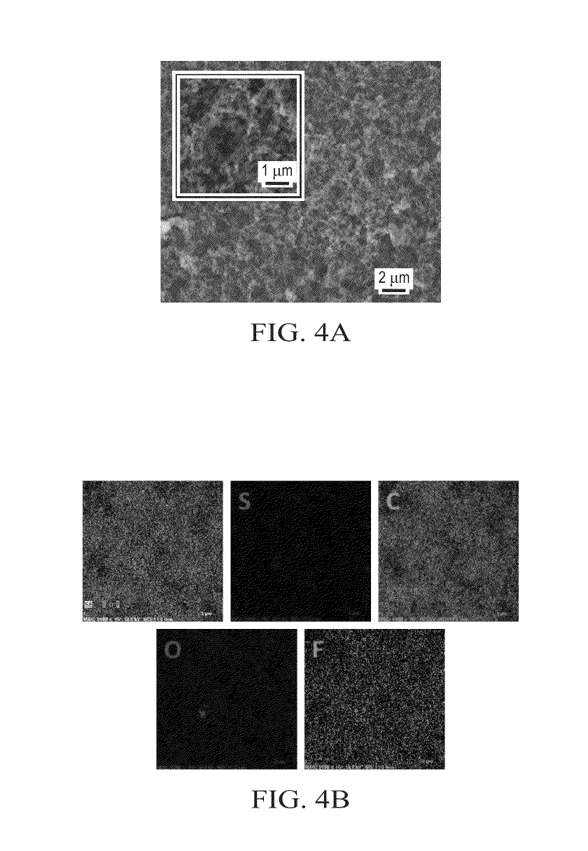

An SEM micrograph (with a high magnification inset) and corresponding elemental mapping analyses of the Celgard layer-facing surface of the carbon coating layer of the bifunctional separator after 200 cycles at a cycling rate of C/5 is provided in FIGS. 4A and 4B. As observed on the cathode-facing surface of the carbon coating, the carbon coating retains its microporous structure. On the Celgard layer-facing surface, no trapped active sulfur materials are observed, and only weak sulfur signals are observed by elemental mapping, while strong carbon signals are observed.

Thus the morphological and elemental analyses indicate that the carbon-coated separator intercepts active sulfur material but does not permit the formation of dense and potentially insulating sulfur agglomerates. The microporous structure of the carbon coating is therefore retained.

### Electrochemical Analysis

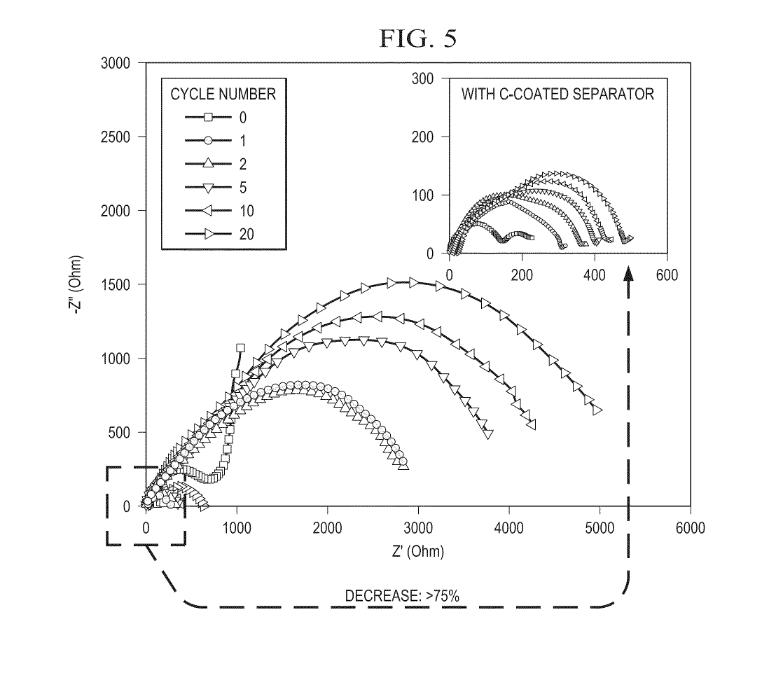

Electrical Impedance Spectroscopy (‘EIS’) analysis was performed with cells containing either the carbon-coated Celgard separator or an uncoated Celgard separator. The EIS data, shown in FIG. 5, demonstrate that charge transfer resistance (R_{CT}, as indicated in the high frequency region) is over 75% lower in cells containing the carbon-coated separator than in cells containing a standard uncoated separator. This reduction represents a significant decrease in cathode resistance. As shown, with cycling, the semicircular impedance plots of the carbon-coated separator cells are much smaller than those of the uncoated separator cells. Without limitation to theory, it is believed that the conductive carbon coating functions as the upper-current collector and provides an additional electron pathway for the low-conductive pure sulfur cathode. Thus, the R_{CT} decreases significantly.

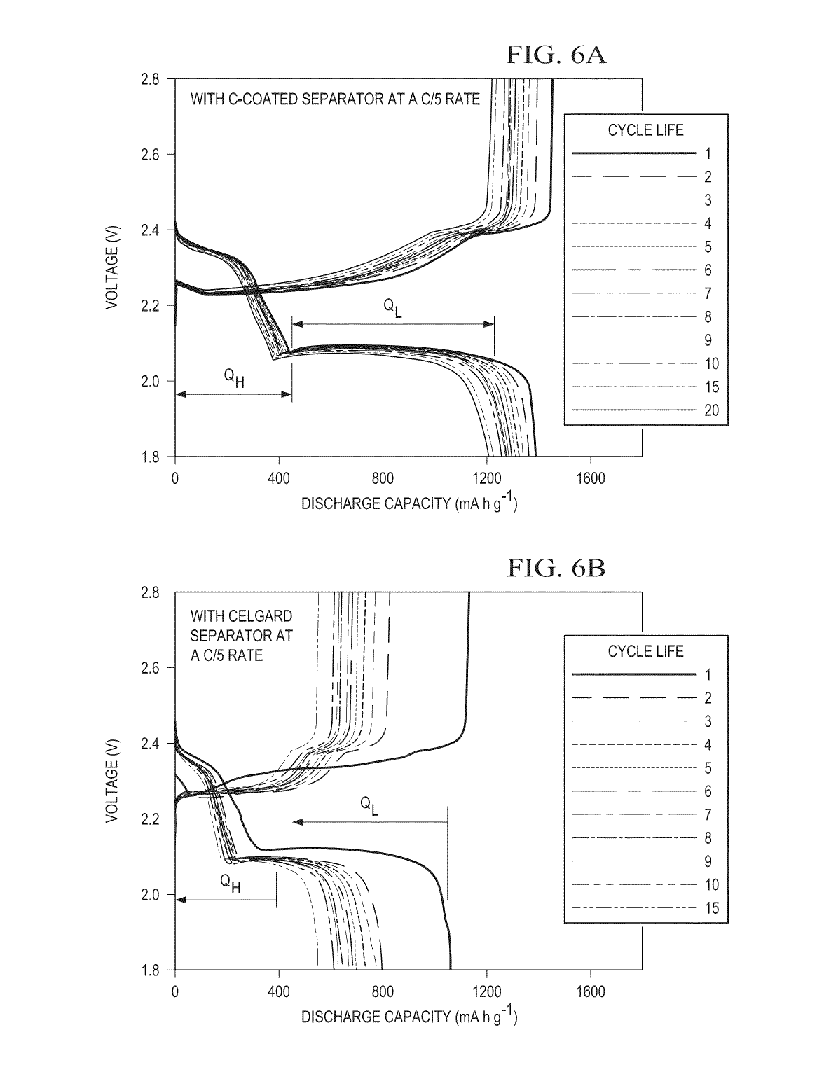

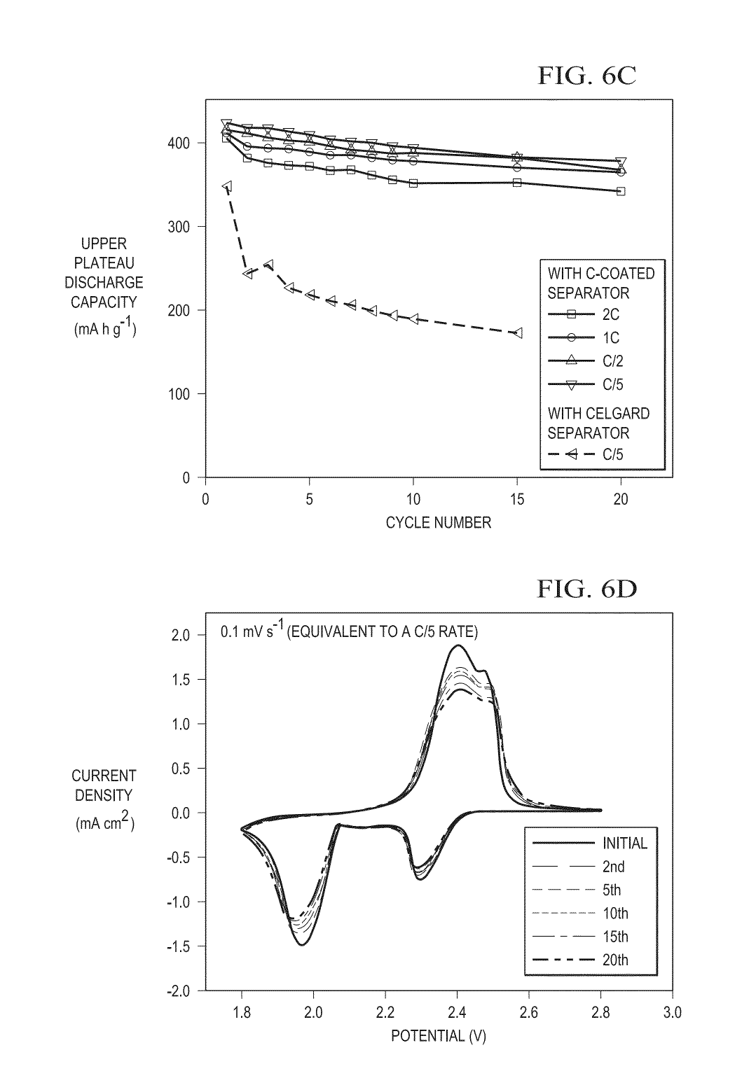

Charge/discharge voltage profiles at a cycling rate of C/5 are provided for cells having carbon-coated (bifunctional) and uncoated (conventional) separators in FIG. 6A and FIG. 6B, respectively. FIG. 6A provides profiles for cycles 1-10, 15, and 20 as indicated, while FIG. 6B provides profiles for cycles 1-10 and 15 as indicated. During discharge of the carbon-coated separator cells, two separate plateaus are observed, indicating the occurrence of two complete reduction reactions. The upper discharge plateau at ˜2.35 V corresponds to the first reduction from elemental sulfur (S₈) to long-chain polysulfides (Li₂Sₓ, 4<x≦8). The corresponding upper plateau discharge capacity (Q_{H}) is 416 mA h g⁻¹, approximately 99% of the theoretical value of 419 mA h g⁻¹, indicating that limited polysulfide diffusion has occurred across the separator. The lower discharge plateau at ˜2.05 V represents the second reduction from long-chain polysulfides to short-chain Li₂S₂/Li₂S.

As apparent from FIGS. 6A and 6B, the carbon coating increases the initial discharge capacity from 1051 mA h g⁻¹ to 1389 mA h g⁻¹, corresponding to an increase in sulfur utilization from 63% to 83%, and the upper discharge plateaus are well-retained in subsequent cycles. Upper and lower discharge capacities (Q_{H} and Q_{L}, respectively) are maintained during cycling for cells having a carbon-coated separator, but significantly diminish with cycling in cells with an uncoated separator. The increased sulfur utilization and conserved discharge plateaus as observed are consistent with the decreased impedance observed by EIS analysis and with interception and reactivation of active cathode materials by the carbon coating layer.

As further apparent from FIG. 6A, during charging of the cells containing the carbon-coated separator, two continuous plateaus are observed at approximately 2.25 V and 2.4 V, which correspond to the reversible oxidation of Li₂S₂/Li₂S to Li₂S₈/S₈. As the voltage approaches 2.8 V, a vertical rise in voltage is seen, indicating a complete charge reaction.

Upper discharge capacity plateaus of the cells containing either carbon-coated separators or uncoated separator at a given cycle number and cycling rate are plotted in FIG. 6C. As shown, the upper plateau capacities of the cells with the carbon-coated separator remain highly reversible at each cycling rate, with only minor decreases in capacity, whereas the upper plateau capacity of the uncoated separator cell decreases to 45% of its original value after ten cycles at a cycling rate of C/5. High cycle stability in cells containing the carbon-coated separators is also observed in the highly conserved overlapping cyclic voltammograms provided in FIG. 6D. The two cathodic peaks and the two adjacent anodic peaks are consistent with the discharge/charge curves of FIG. 6A.

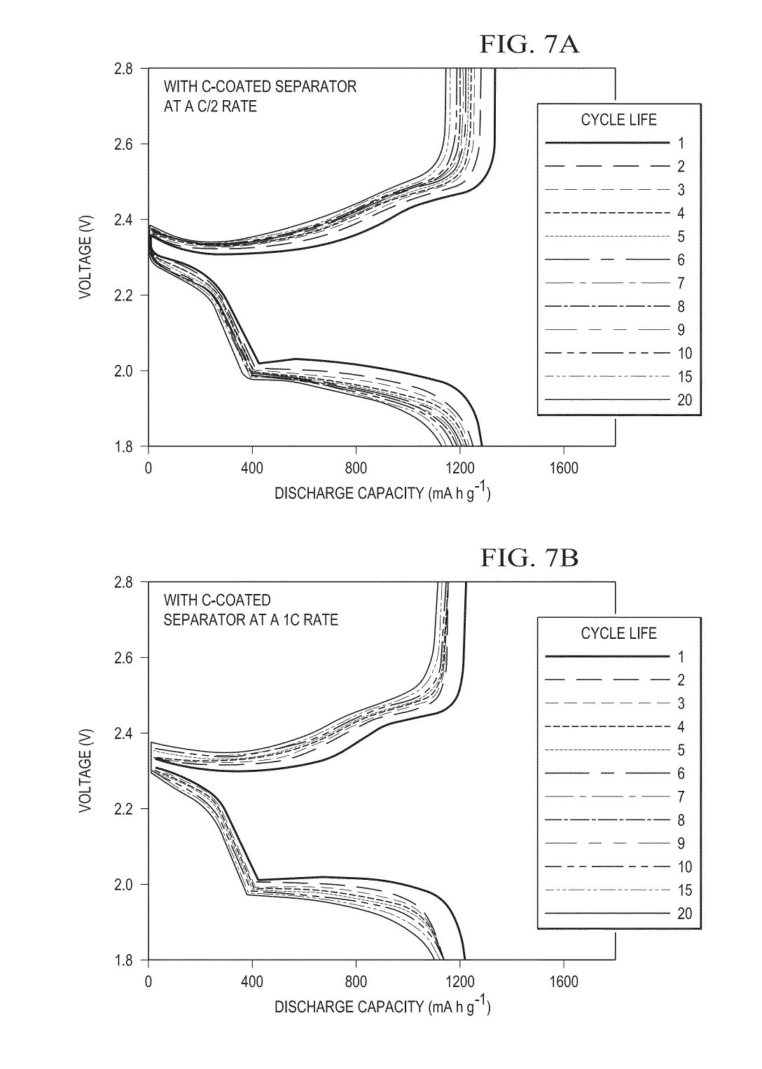

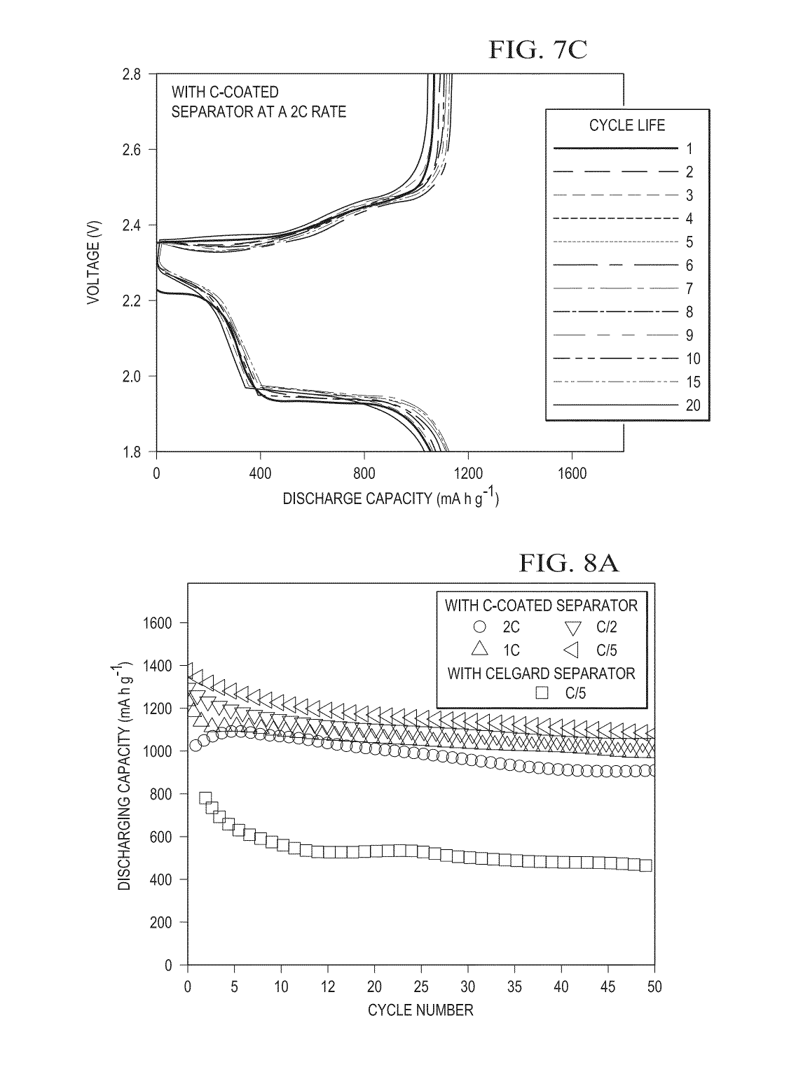

FIGS. 7A-C provide charge/discharge voltage profiles for cycles 1-10, 15, and 20 for cells containing the carbon-coated separator with higher cycling rates of C/2, 1C, and 2C, respectively. Stable cycling performance comparable to the performance observed at a cycling rate of C/5 (as shown in FIG. 6A) is observed at these higher cycling rates.

Without limitation to theory, it is believed that these electrochemical analyses are strongly indicative of inhibition of polysulfide diffusion and high reactivation of active materials during cycling in cells containing the carbon-coated separators.

Electrochemical Stability with Extended Cycling and Rest

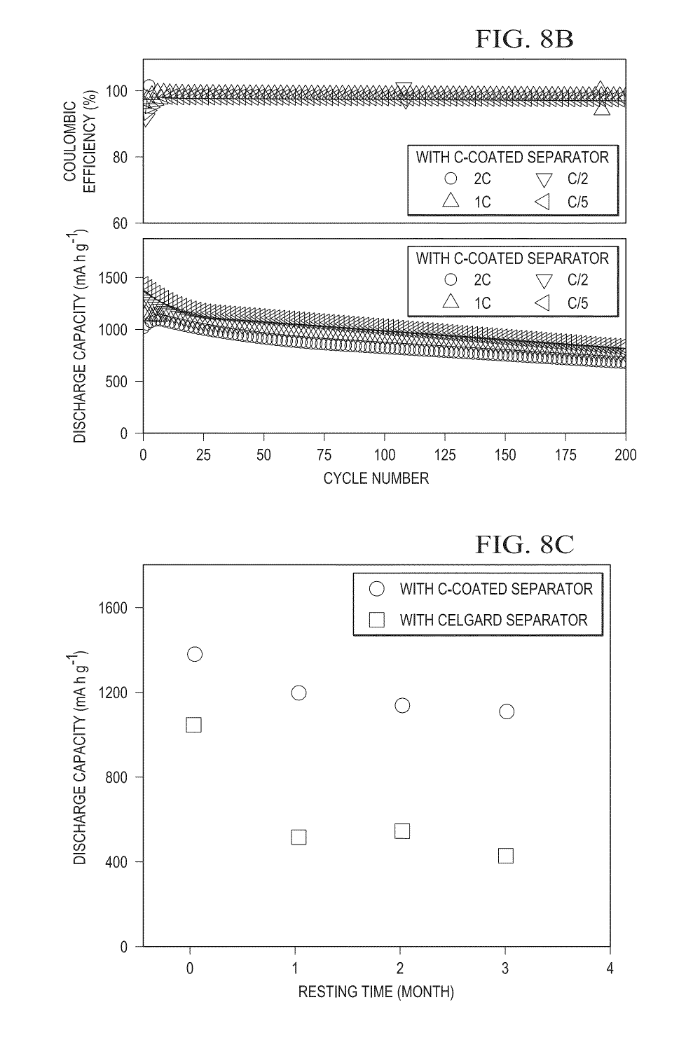

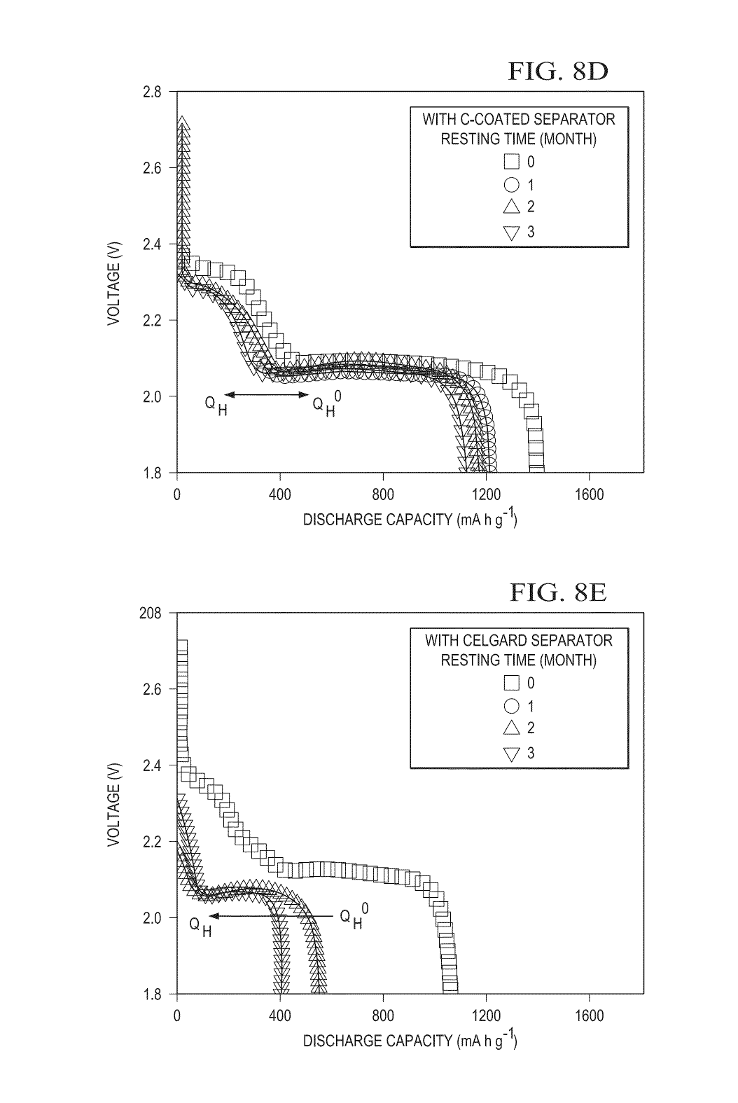

FIG. 8A provides plots of discharge capacity for cycles 1-50 for cells containing the carbon-coated separator or an uncoated separator; cells containing the carbon-coated separator were cycled at various rates from C/5 to 2C. As shown, initial discharge capacities for the cells containing the coated separator were 1389, 1289, 1220, and 1045 mA h g⁻¹ at discharge rates of C/5, C/2, 1C, and 2C, respectively. After 50 cycles, the reversible capacities approach 1112, 1074, 1021, and 920 mA h g⁻¹, corresponding to capacity retention of 80%, 83%, 84%, and 88%, respectively, for these cycling rates. The cells containing the carbon-coated separator thus exhibit stable cyclability and remain highly reversible over a wide range of cycling rates. In contrast, the cell containing an uncoated separator exhibits an initial discharge capacity of 1051 mA h g⁻¹, which decreases to 785 mA h g⁻¹ for the second cycle and 500 mA hg⁻¹ after 50 cycles.

FIG. 8B provides plots of discharge capacity and Coulombic efficiency for cycles 1-200 for cells containing the carbon-coated separator at cycling rates of C/5, C/2, 1C and 2C. The reversible capacities of the cells after 200 cycles are 828, 810, 771, and 701 mA h g⁻¹, with observed capacity fade of 0.2%, 0.19%, 0.18%, and 0.16% per cycle, for cycling rates of C/5, C/2, 1C, and 2C, respectively. The average Coulombic efficiency of the cells at the various cycling rates was over 98.2%. No abrupt capacity fade was observed with extended cycling, indicating good mechanical integrity of the carbon coating.

The excellent cycling stability observed in cells containing the carbon-coated separator indicates that the carbon coating provides a stable electrochemical environment for the pure sulfur cathode. Without limitation to theory, long-term cyclability as observed indicates interception, reactivation, and reuse of polysulfide active materials. As demonstrated by morphological analysis, this can occur in the microporous carbon coating layer.

Discharge capacity of cells containing the carbon-coated separator or an uncoated separator was measured on the same day that the cells were constructed or 1, 2, or 3 months after construction. As shown in FIG. 8C, the discharge capacity of cells containing the uncoated separator decreased from 1051 mA h g⁻¹ shortly after construction to 520 mA h g⁻¹ after one month. Cells containing the carbon-coated separator, in contrast, retain 86% of initial capacity one month after construction and 81% of initial capacity over 3 months. Observed static capacity fade was 0.6% per day for cells containing the uncoated separator and 0.19% for cells containing the coated separator.

FIG. 8D shows discharge curves for cells containing the carbon-coated separator after rest periods of 0-3 months. As shown, after a decrease in capacity from 1389 mA h g⁻¹ to 1204 mA h g⁻¹ after the first month, the capacity of the cell remains fairly stable with additional rest. The upper and lower discharge plateaus are well-conserved, indicating that the active material is retained within the cathode region of the cell. FIG. 8E shows discharge curves for cells containing the uncoated separator after rest periods of 0-3 months. The cells exhibit marked capacity fading and reduction of the upper discharge voltage plateau after 1 month. These results are consistent with diffusion of polysulfides across the separator and formation of inactive precipitates of active material during cell storage, resulting in cathode degradation and static capacity fading.

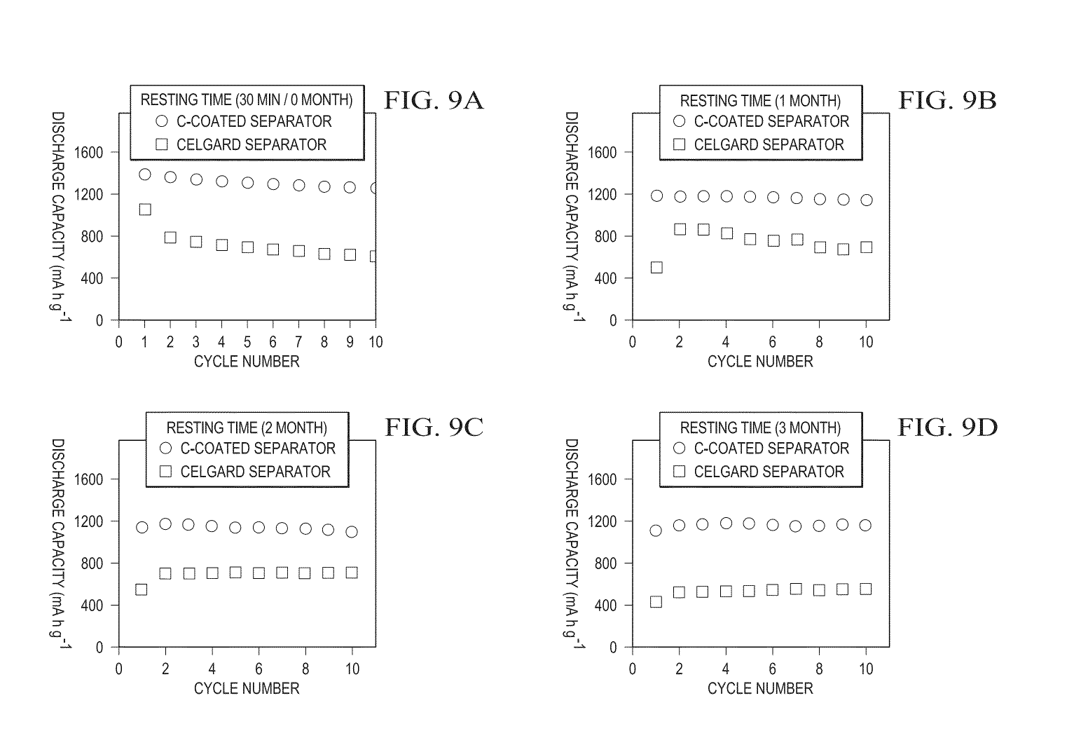

Reversible capacities of cells containing the uncoated or carbon-coated separators over cycles 1-10 at a cycling rate of C/5 after storage (i.e., resting) of the cells for 0 months, 1 month, 2 months, and 3 months are shown in FIGS. 9A, 9B, 9C, and 9D, respectively. Even after resting for three months, cells containing the carbon-coated separator exhibit stable cycling and retained discharge capacity.

Morphological analysis of stored cells containing carbon-coated or uncoated separators indicates cathode degradation and formation of insulating precipitates in cells containing the uncoated separators that is not observed in cells containing coated separators. Low- and high-magnification SEM micrographs of the cathode of an uncycled cell having the uncoated Celgard separator after storage for one month are provided in FIG. 10A and FIG. 10B, respectively. A region of insulating precipitates on the cathode material are indicated by dashed white circling, and pits on the cathode surface indicating removal of active material are indicating with dashed red circling. Corresponding low- and high-magnification SEM micrographs of the cathode of an uncycled cell having the carbon-coated Celgard separator after storage for one month are provided in FIG. 11A and FIG. 11B, respectively. Insulating precipitates and pitting are not observed on the cathodes of cells containing the carbon-coated separator.

The self-discharge constants (K_{S}) of the cells containing uncoated separators and carbon-coated separators can be modeled by comparing the upper plateau discharge capacity after rest (Q_{H}) and the initial upper plateau discharge capacity (Q_{H°}) at resting time TR according to the following formula:

ln(Q_{H}/Q_{H°})=−K_{S}×T_{R} (1)

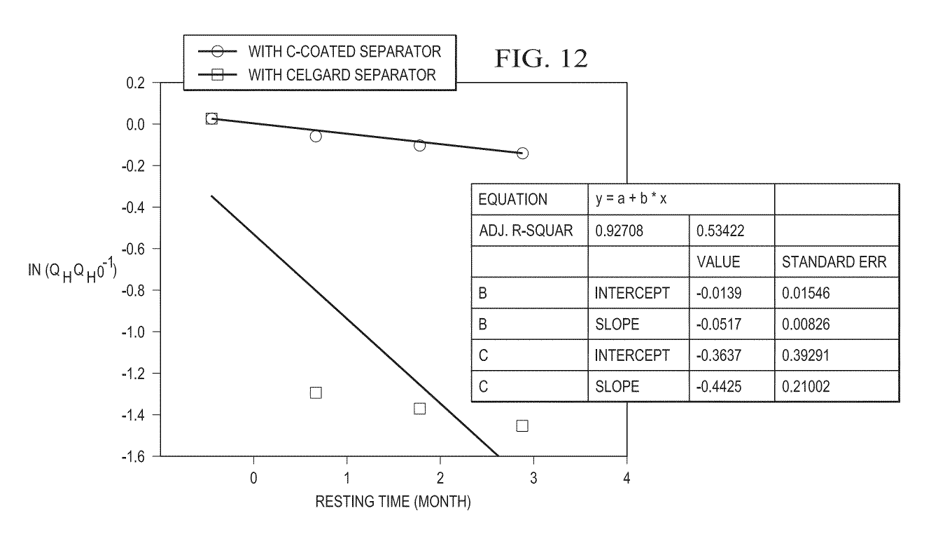

As plotted and described in FIG. 12, cells containing the carbon-coated separator exhibit a K_{S} as low as 0.05 per month, the lowest K_{S} observed for Li—S cells to date. In contrast, the K_{S} of cells containing the uncoated Celgard separator is as high as 0.44 per month.

The carbon-coated separators described above are lightweight, inexpensive, and easy to construct, and result in markedly improved dynamic and static cycle stability relative to uncoated separators even with high cathode sulfur content. Without limitation to theory, it is believed that the carbon coating layer entraps dissolved polysulfide active cathode materials and conducts electrons to the materials to permit their reactivation, thereby enhancing reutilization of the cathode materials and preventing deposition of insulating polysulfide precipitates.

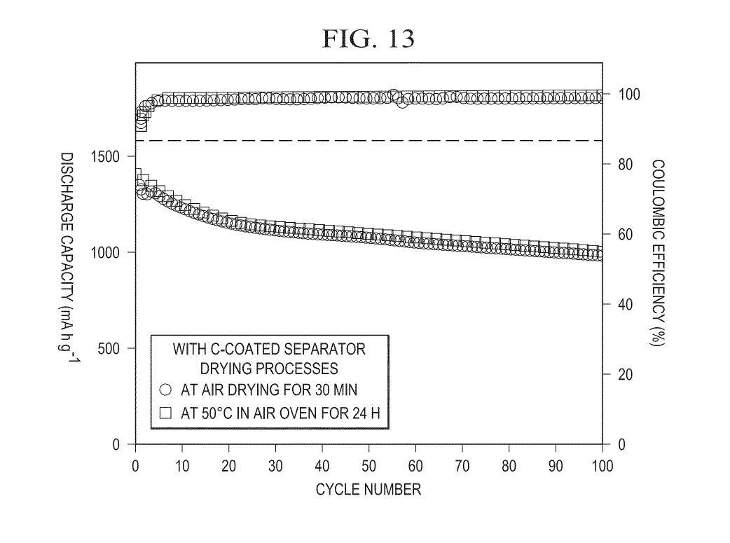

As shown in FIG. 13, Li—S batteries containing a bifunctional separator wherein the separator with the carbon coating layer was air-dried for thirty minutes at room temperature exhibit comparable cycling performance. Fabrication of bifunctional separators according to the present disclosure can therefore be even further simplified without significantly compromised performance.

Bifunctional Separators with a MWCNT Coating Layer

Electrochemical Li—S cells having bifunctional separators consisting of a Celgard polypropylene sheet and a layer of multi-walled carbon nanotubes (MWCNT) on the cathode side of the Celgard sheet were constructed. Electrochemical performance of the cell was evaluated and the separators and the cathodes were characterized. The cells containing the carbon-coated separators exhibited high initial discharge capacity (1324 mA h g⁻¹) with a high reversible capacity of 881 mA h g⁻¹ after 150 cycles at a cycling rate of C/5, high rate performance from C/5 to 1C rates, and a low capacity fade rate of 0.14% over 300 cycles.

### Materials and Methods

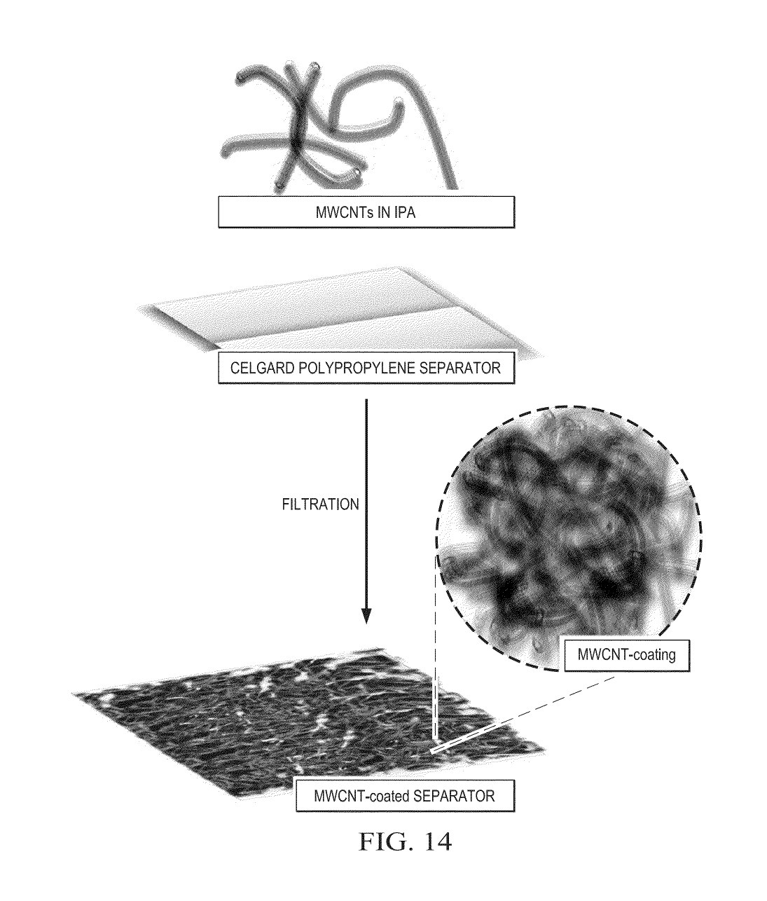

To fabricate the bifunctional separators, MWCNT layers were deposited on commercial Celgard 2500 polypropylene separators. 0.025 g of PD30L520 MWCNTs having a hollow structure with an outer diameter of 15-45 nm, a length of 5-20 μm, and greater than 95% purity were dispersed in 500 mL of isopropyl alcohol by high-power ultrasonication for 10 minutes. The MWCNT suspension was then filtered through a Celgard separators by vacuum suspension. After drying at 50° C. for 24 hours in an air oven, the MWCNTs were arranged as a flexible bundled nanotube layer closely attached to the Celgard separator. The resulting bifunctional separators were cut into circular discs with a diameter of 19 mm. The MWCNT-coated separator construction is illustrated schematically in FIG. 14.

Sulfur cathodes were prepared by mixing precipitated sulfur, Super P carbon black powder, and polyvinylidene fluoride binder in proportions of 70%, 20%, and 10% by weight in an N-methyl-2-pyrrolidone (NMP) solution. The mixture was stirred for two days and then cast onto an aluminum foil current collector. NMP was evaporated in an air oven at 50° C. for 24 hours. The dried cathodes were cut into circular discs with a diameter of 12 mm. The sulfur loading in the final cathode discs was approximately 2.0 mg cm⁻².

CR2032-type coin cells were assembled in an argon-filled glove box. The sulfur cathodes and MWCNT-coated separators were dried in a vacuum oven at 50° C. for one hour before cell assembly. Cells contained a lithium foil anode from Aldrich, a sulfur cathode prepared as described, nickel foam spacers, electrolyte, and either an uncoated Celgard 2500 separator or a Celgard 2500 separator coated with a layer of MWCNT as described, the MWCNT layer facing the cathode side of the cell. The electrolyte contained 1.85 M LiCF₃SO₃ salt and 0.1 M LiNO₃ co-salt in a 1:1 solvent ratio of DME and DOL. All electrolyte materials were purchased from Acros Organics. The assembled cells were allowed to rest for 30 minutes at 25° C. before electrochemical analysis.

Discharge/charge voltage profiles and cyclability data were collected with a programmable battery cycler (Arbin Instruments) with a voltage window of 1.8 V-2.8 V at cycling rates between C/5 to 1C. The cutoff potential of 1.8 V was selected to avoid an irreversible reduction at ˜1.6 V due to the LiNO₃ co-salt. Cyclic voltammograms (CV) were recorded with a universal potentiostat (VoltaLab PGZ 402, Radiometer Analytical) with a voltage window of 1.8-2.8 V at a scan rate of 0.1 mVs⁻¹, equivalent to a cycling rate of C/5. Microstructural analysis and elemental mapping of the MWCNT-coated separator and sulfur cathode were conducted with a field emission scanning electron microscope (FE-SEM, FEI Quanta 650 SEM) equipped with EDX spectrometers. Surface area and pore volume of the MWCNT were assessed by the Brunanuer-Emmett-Teller (BET) method at 77 K with an automated gas sorption analyzer (AutoSorb iQ2, Quantachrome Instruments). The MWCNT-coated separators and sulfur cathodes were retrieved from cells inside an argon-filled glove box and transported in an argon-filled sealed vessel prior to analysis. EIS data were obtained with an impedance analyzer (SI 1260) and electrochemical interface (SI 1287) from 1 MHz to 100 mHz with an AC voltage amplitude of 5 mV.

### Characterization

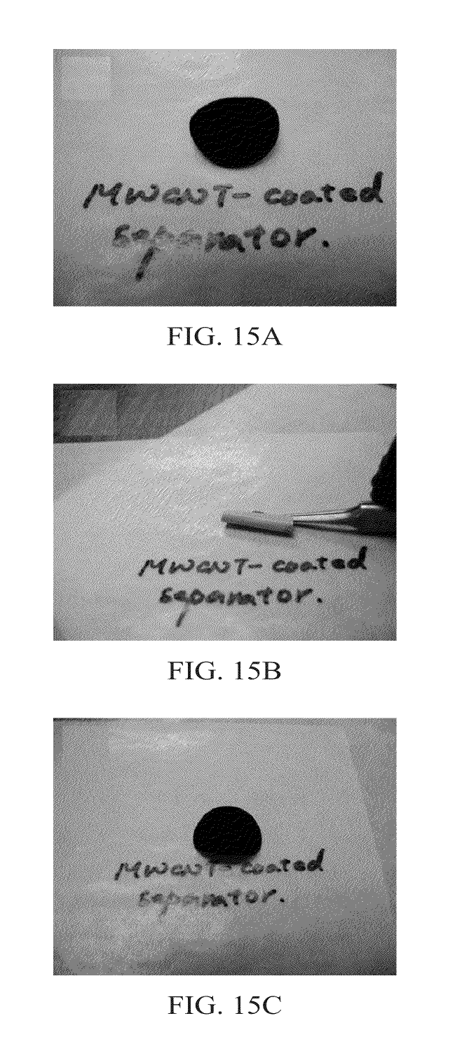

As demonstrated in FIG. 15, the MWNCT-coated separators recover their shape after rolling and folding, indicating strength and flexibility. The weight of the MWCNT coating is 0.17 mg cm⁻², while the weights of the Celgard separator and cathode active material are 1.0 mg cm⁻² and 2.0 mg cm⁻², respectively. The light weight of the MWCNT layer permits total sulfur loading in the cell of 65% by weight, which exceeds sulfur loading of many high-performance Li—S cells in the prior art.

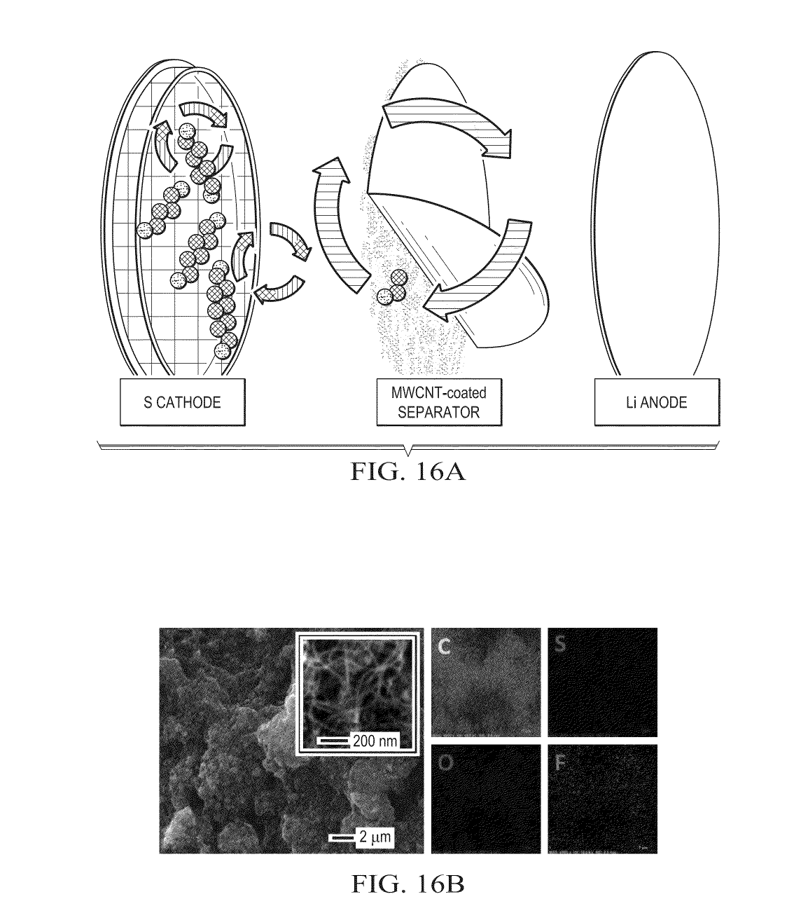

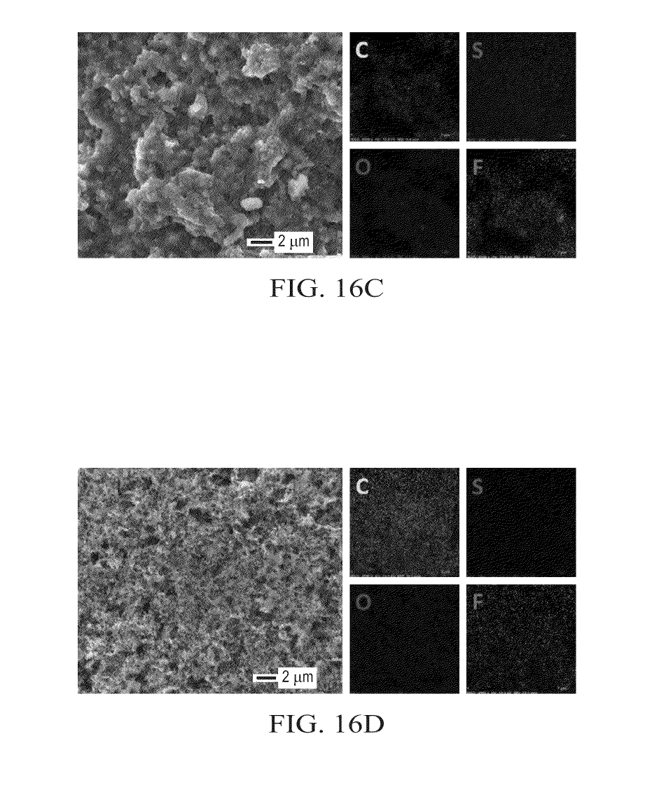

The configuration of the cells containing the MWCNT-coated separator is illustrated schematically in FIG. 16A. Without limitation to theory, the MWCNT coating, which faces the sulfur cathode, intercepts diffusing polysulfide species (indicated as red arrows) before they migrate through the polypropylene separator, thereby restricting them within the cathode region of the cell and stabilizing the electrochemical environment (indicated with blue arrows) of the cell.

FIG. 16B presents SEM micrographs and corresponding EDX elemental mapping of the MWCNT coating (prior to cell cycling), with a high-magnification region shown in the figure inset. As shown, the MWCNT coating layer consists of curved, interwoven MWCNTs forming a bundled, microporous filter on the Celgard separator. As measured by gas sorption analysis, the MWCNT coating possesses a high surface area of 410 m² g⁻¹, with a total pore volume of 2.76 cm³ g⁻¹.

SEM micrographs and corresponding elemental mapping of the surface of the MWCNT coating facing the cathode after cycling are provided in FIG. 16C. Obstructed active cathode material is apparent in the SEM micrographs, and the corresponding EDX elemental mapping displays clear elemental sulfur signal (red) distributed in the carbon (green) carbon matrix. The sulfur signal is diffuse and without dense spots, while the elemental carbon signal remains strong and distinguishable, indicating that nonconductive agglomerations of sulfur do not form on the MWCNT separator.

SEM micrographs and corresponding elemental mapping of the surface of the MWCNT coating facing the Celgard layer after cycling are provided in FIG. 16D. The coating retains its microporous surface, and no polysulfide agglomerations are apparent, as further indicated by the strong carbon signal (green) and weak sulfur signal (red) observed by elemental mapping. The weak sulfur signal may be due to the LiCF₃SO₃ salt rather than dissolved polysulfides.

### Electrochemical Analysis

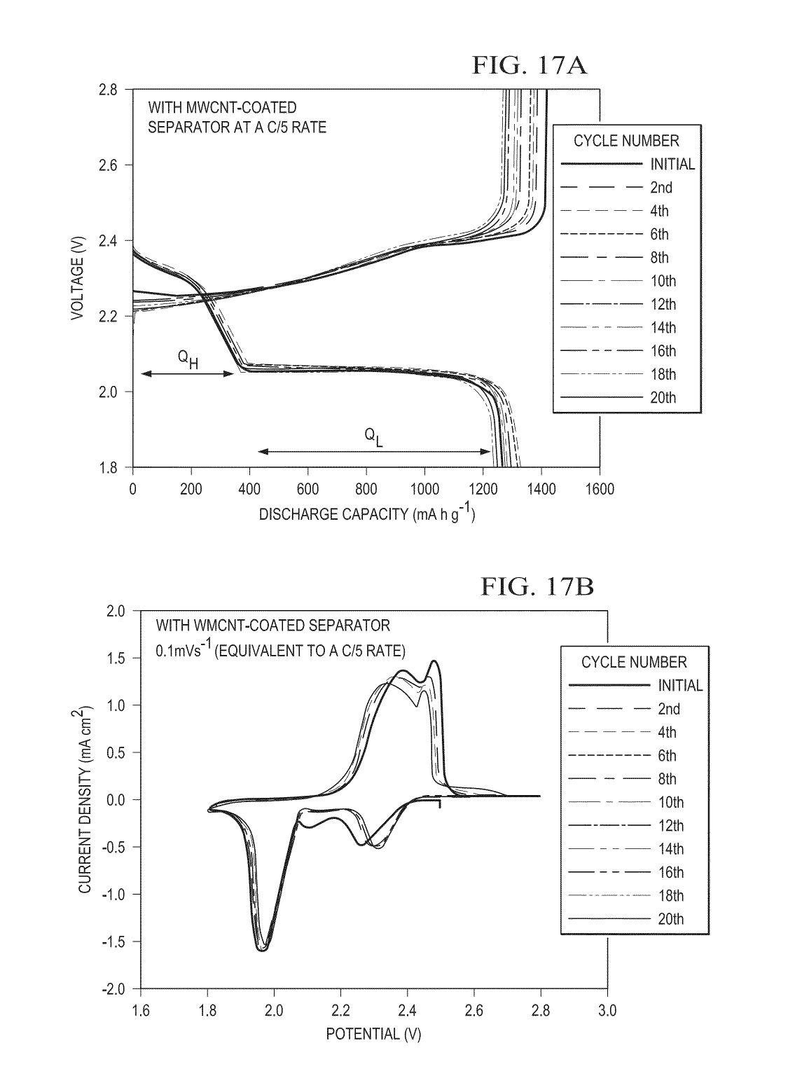

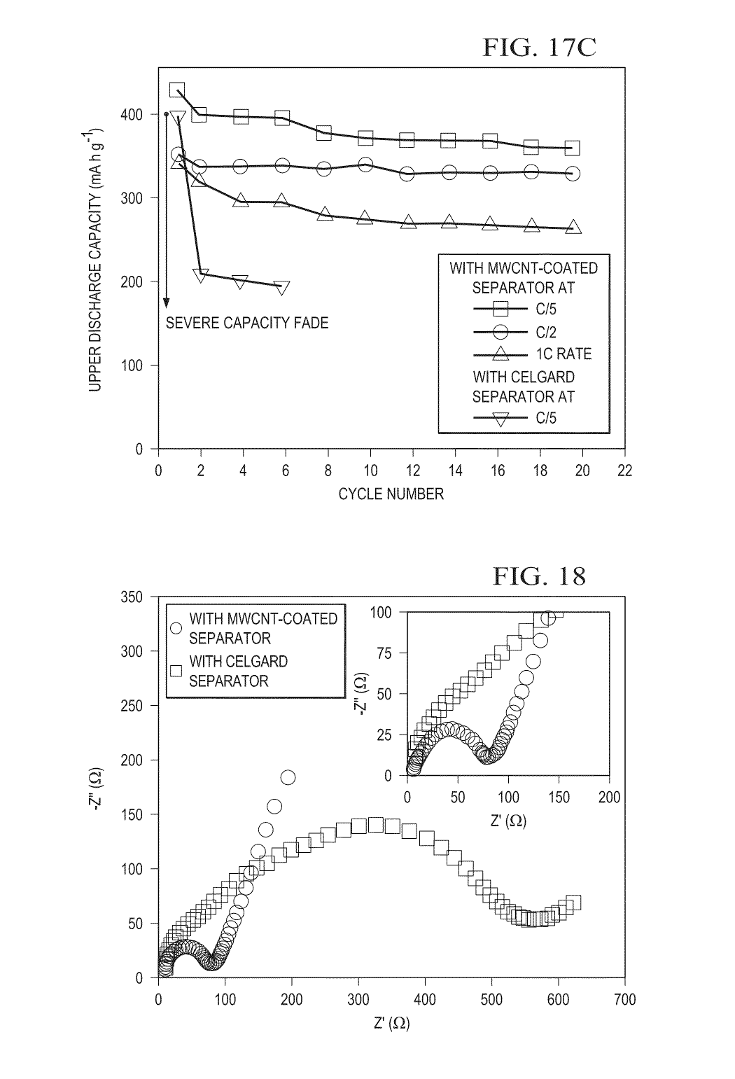

Electrochemical analyses of a cell containing the MWCNT-coated separator are provided in FIG. 17. FIG. 17A shows discharge/charge voltage profiles of the cell during cycles 1-20 at a cycling rate of C/5. Initial discharge capacity is 1324 mA hg⁻¹, corresponding to sulfur utilization approaching 80%. The upper and lower discharge plateaus observed at 2.35 V and 2.05 V correspond, respectively to the reduction of sulfur to long-chain polysulfides and the reduction of long-chain polysulfides to Li₂S₂/Li₂S. The continuous charge plateaus observed at 2.25 V and 2.40 V correspond to reversible oxidation of Li₂S₂/Li₂S to Li₂S₈/S. The vertical voltage rise from 2.4 V to 2.8 V at the end of the charge plot indicates a complete charge process, with limited polysulfide shuttling.

Cyclic voltammograms of the cell containing the MWCNT-coated separator for cycles 1-20 at a scanning rate of 0.1 mVs⁻¹ are shown in FIG. 17B. Two cathodic peaks and two overlapping anodic peaks are observed, and correspond to the discharge/charge curves of FIG. 17A, consistent with typical sulfur redox reactions of Li—S cells. An overpotential is observed in the initial cycle but not subsequent cycles, suggesting rearrangement of the active cathode material to electrochemically favorable positions. No decrease in peak intensity or potential shift is observed in subsequent CV scans, demonstrating high reversibility of cells containing the MWCNT-coated separator.

Upper plateau discharge capacities (Q_{H}) for cells containing the MWCNT-coated separator or an uncoated separator are graphed in FIG. 17C. Values for cells containing the MWCNT-coated separator are provided for cycles 1-20 at cycling rates of C/5, C/2, or 1C; values for cells containing the uncoated separator are provided for cycles 1-6 at a cycling rate of C/5. The initial Q_{H} for cells containing the MWCNT-coated separator is 414 mA h g⁻¹, which is approximately 99% of the theoretical value, indicating suppression of the severe polysulfide diffusion. During cycling, the Q_{H} of cells containing the MWCNT-coated separator remains highly reversible at each of the cycling rates examined. The Q_{H} of the cell containing the uncoated separator, however, decreases to 53% of its original value after the initial cycle at a cycling rate of C/5, demonstrating severe capacity fade in cells with conventional separators.

FIG. 18 provides EIS data for cells containing the MWCNT-coated separator or uncoated separator. A significantly smaller impedance plot is observed for cells containing the MWCNT-coated separators, with charge-transfer resistance of the cell reduced by about 85%.

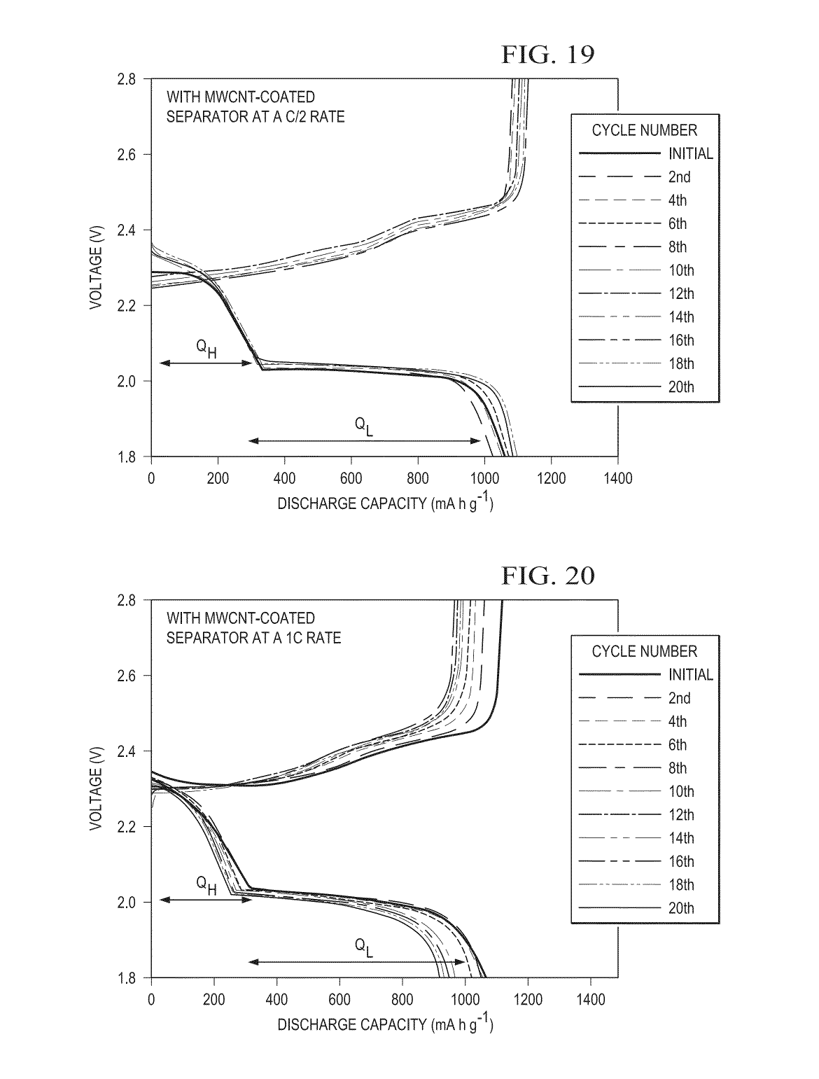

FIG. 19 and FIG. 20 provide discharge/charge curves of cells for containing the MWCNT-coated separator for cycles 1-20 at cycling rates of C/2 and 1C, respectively. As shown, the cells containing the MWCNT-coated separator exhibit overlapping discharge curves and charge curves over repeated cycling, indicating high cycle stability and rate performance.

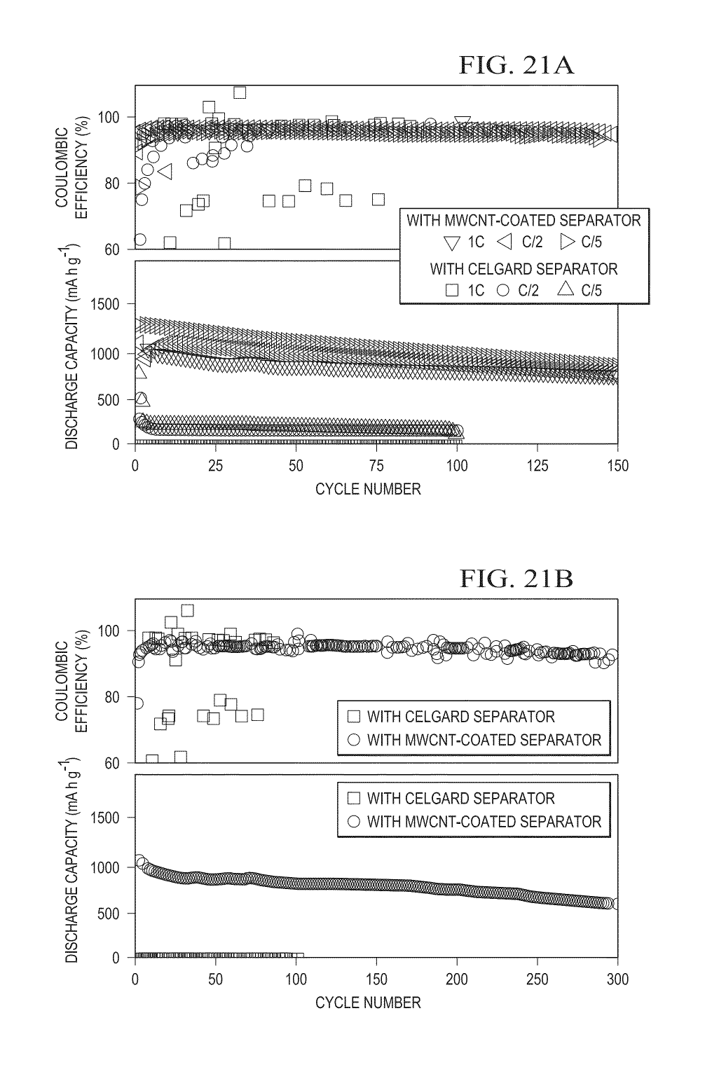

Discharge capacity and Coulombic efficiency data for cells containing MWCNT-coated separators (for cycles 1-150) or uncoated separators (for cycles 1-100) at cycling rates of C/5, C/2, and 1C are provided in FIG. 21A. For cells containing MWCNT-coated separators, initial discharge capacities of 1324, 1107, and 1073 mA hg⁻¹ are observed, corresponding to sulfur utilization of 79%, 66%, and 64% with cycling at rates of C/5, C/2, and 1C rates, respectively. Stable cycling is observed for 150 cycles, and after 150 cycles, the reversible discharge capacities observed are 881, 809, and 798 mA hg⁻¹ at cycling rates of C/5, C/2, and 1C, respectively. The measured capacity fade at the various cycling rates is only 0.19%±0.03% per cycle. In contrast, and as shown, cells containing the uncoated separator exhibit low capacity and experience severe capacity fade and short cycle life.

Discharge capacity and Coulombic efficiency data for cells containing MWCNT-coated separators (for cycles 1-300) or uncoated separators (for cycles 1-100) at a high cycling rate of 1C are provided in FIG. 21B. The reversible capacity of the cell containing the MWCNT-coated separator is 621 mA hg⁻¹ after 300 cycles, corresponding to a capacity fade rate of 0.14% per cycle. Coulombic efficiency is greater than 96% after 300 cycles.

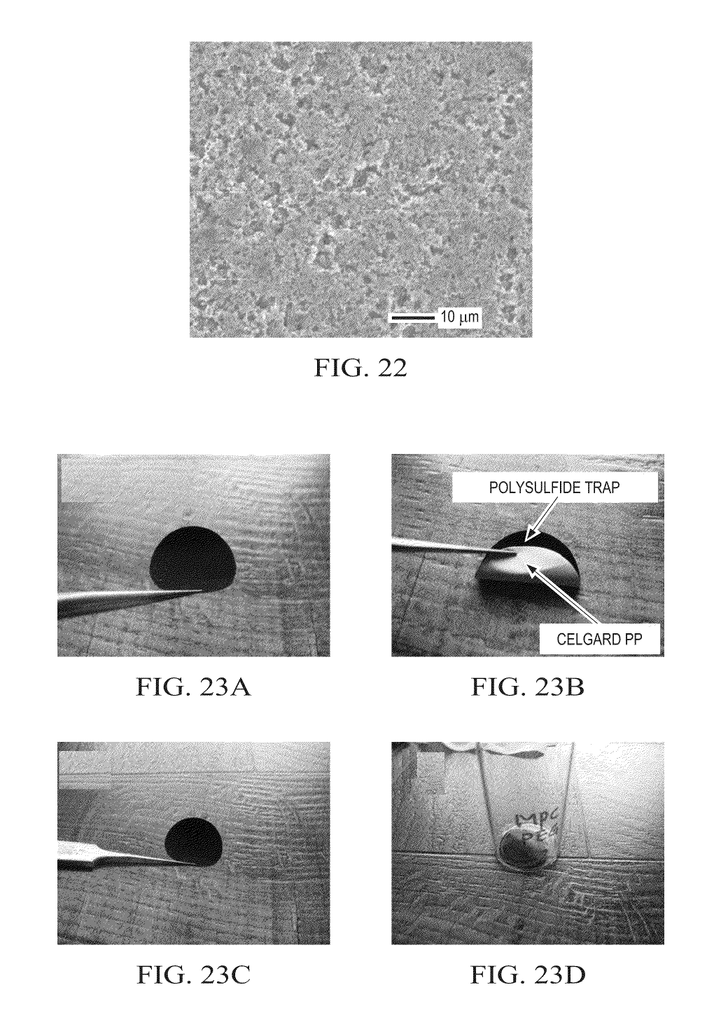

The microstructure of the surface of the sulfur cathode in an Li—S battery containing a bifunctional separator with a MWCNT coating layer after 150 cycles at a cycling rate of C/5 is shown in FIG. 22. Some active cathode material loss (pitting) is apparent, but large insoluble precipitates are not observed.

Thus, MWCNT-coated separators exhibit stable cyclability with high capacity. The high reversible capacity with extended cycling, as well as the complete overlap of upper discharge profiles during cycling indicates that a high proportion of active cathode materials are reactivated rather than inactivated as insoluble and insulating precipitates. Without limitation to theory, it is believed that the improved discharge capacity, reversible capacity and cycling stability observed in cells containing MWCNT-coated separators is due to inhibition of polysulfide dissolution through the separator and good reactivation of active cathode material. In particular, and as evidenced by EDX mapping, it is believed that the microporous coating localizes electrolyte containing dissolved polysulfides and provides microporous absorption sites for trapping the intercepted polysulfides. The long-range porous network of the MWCNT layer promotes charge transport and electrolyte immersion to reactive the trapped active cathode material. Electron transport to the trapped active material is enhanced by the conductive MWCNT layer during cycling to reactive the trapped active material and to suppress the formation of inactive precipitates, while the uneven porous structure of the MWCNT coating disfavors the formation of the large inactive precipitates.

Bifunctional Separators with a Polymer-Coated Microporous Carbon Layer

Electrochemical cells bifunctional separators with a polymer-coated microporous carbon layer (“MPC/PEG-coated separators”) were constructed. Electrochemical performance of the cell was evaluated and the separators and the cathodes were characterized. The cells containing the bifunctional separators exhibited high initial discharge capacity (1307 mA g⁻¹) with high reversibility and cyclability.

### Materials and Methods

### i) Bifunctional Separators Having a Polymer-Coated Carbon Powder Layer

Bifunctional separators were fabricated by thin-film coating a microporous carbon/PEG slurry on one side of a Celgard 2500 polypropylene (PP) membrane (CELGARD) by a tape casting method. The microporous carbon/PEG slurry was prepared by mixing 80 wt. % conductive carbon black (Black Pearls 2000, CABOT) and 20 wt. % polyethylene glycol (PEG Aldrich) in isopropyl alcohol (IPA) overnight. After drying at 50° C. for 24 h in an air-oven, the resultant coating (0.15 mg cm⁻²) formed a thin-film polysulfide trap with a thickness of 8 μm attached to the Celgard separator. The coated separators were cut into circular discs and inserted into coin cells (as described below). The carbon-coated side faced the cathode of the cells.

### ii) Sulfur Cathodes

Pure sulfur cathodes from a slurry of active sulfur material made by mixing precipitated sulfur, Super P carbon black powder, and polyvinylidene fluoride (70, 15%, and 15% by weight, respectively) in N-methyl-2-pyrolidone for 2 days. The sulfur active material was tape-cast onto aluminum foil current collectors and dried for 24 hours at 50° C. in an air oven, followed by roll-pressing and cutting into circular discs to form the pure sulfur cathodes. The sulfur loading in the final cathode discs was 1.1 to 1.3 mg/cm².

The final sulfur content of finished cells was approximately 65 wt. % with cathode active material loading of 2.0 mg cm⁻².

iii) Cell Assembly

CR2032-type coin cells were assembled with the pure sulfur cathode, MPC/PEG-coated separator, lithium anode (as described above), and nickel foam spacers. The MPC/PEG-coated separator was placed with the polysulfide trap facing the pure sulfur cathode. Cell components were dried in a vacuum oven for one hour at 50° C. prior to cell assembly. All cells were assembled in an argon-filled glove box. The electrolyte was prepared by dissolving 1.85 M LiCF₃SO₃ salt (Acros Organics) and 0.1 M LiNO₃ co-salt (Acros Organics) in a 1:1 volume ratio of 1,2-dimethoxyethane (DME, Acros Organics) and 1,3-dioxolane (DOL, Acros Organics).

### iv) Characterization

Microstructural, morphological, and elemental analyses of the MPC/PEG-coated separator and cathodes were conducted before and after cycling by a field emission scanning electron microscope (FE-SEM) (FEI Quanta 650 SEM) equipped with an energy dispersive X-ray spectrometer (EDX) for collecting elemental mapping signals. Cycled cathodes were retrieved inside an argon-filled glove box, rinsed with blank electrolyte for 3 minutes, and transported in an argon-filled sealed vessel. Blank electrolyte used for rinsing the cycle samples contained only DME/DOL in a volume ratio of 1:1. Samples of the surface of the polymer-coated microporous conductive layer facing the electrically insulative layer were prepared by scraping the cycled MPC/PEG coating from the cycled composite separator by a razor blade. Nitrogen adsorption-desorption isotherms were measured at −196° C. with an automated gas sorption analyzer (AutoSorb iQ2, Quantachrome Instruments). The surface area was calculated by the Brunner-Emmett-Teller (BET) method with a 7-point BET model with the correlation coefficient above 0.999. The pore-size distributions and pore volumes were determined by the Barrett-Joyer-Halenda (BJH) method, Horvath-Kawazoe (HK) method, and a density functional theory (DFT) model. Thermal gravimetric analysis (TGA) data were collected with a thermo-gravimetric analyzer (TGA 7, Perkin-Elmer) at a heating rate of 5° C. min⁻¹ from room temperature to 500° C. with an air flow of 20 mL min⁻¹ to determine the sulfur content in the sulfur-MPC nanocomposite.

### Electrochemical Analyses:

The assembled cells were allowed to rest for 30 minutes at 25° C. before the electrochemical measurements. The electrochemical impedance spectroscopy (EIS) data were recorded with a computer-interfaced impedance analyzer (SI 1260 & SI 1287, Solartron) in the frequency range of 1 MHz to 100 mHz with an applied voltage of 5 mV. The cyclic voltammetry (CV) data were performed with a universal potentiostat (VoltaLab PGZ 402, Radiometer Analytical) between 1.8 and 2.8 V at a scan rate of 0.1 mV s⁻¹. The discharge/charge profiles and cyclability data were collected with a programmable battery cycler (Arbin Instruments). The cells were first discharged to 1.8 V and then charged to 2.8 V for a full cycle. The complete electrochemical cycling performance was investigated at a C/5 rate, based on the mass and theoretical capacity of sulfur (1C=1672 mA h g⁻¹). The rate capability of cells was measured at C/5, C/2, and 1C rates.

### Characterization

A representative bifunctional separator having a polymer-coated microporous layer is depicted in FIGS. 23A-D. FIG. 23A shows a freshly prepared MPC/PEG-coated separator; FIG. 23B shows the same separator during mechanical folding; and FIG. 23C depicts the same separator after folding. As evident from FIG. 23C, the separator maintains its initial shape and retains the coating layer after folding. FIG. 23D depicts an MPC/PEG separator after cycling; some morphological changes are apparent.

The MPC/PEG layer has a thickness of ˜8 μm and a weight of 0.15 mg cm⁻², much lower than the weight of the Celgard separator (1.0 mg cm⁻²). The carbon-coated separator cells therefore retain high sulfur loading of approximately 65% by weight in the cathode.

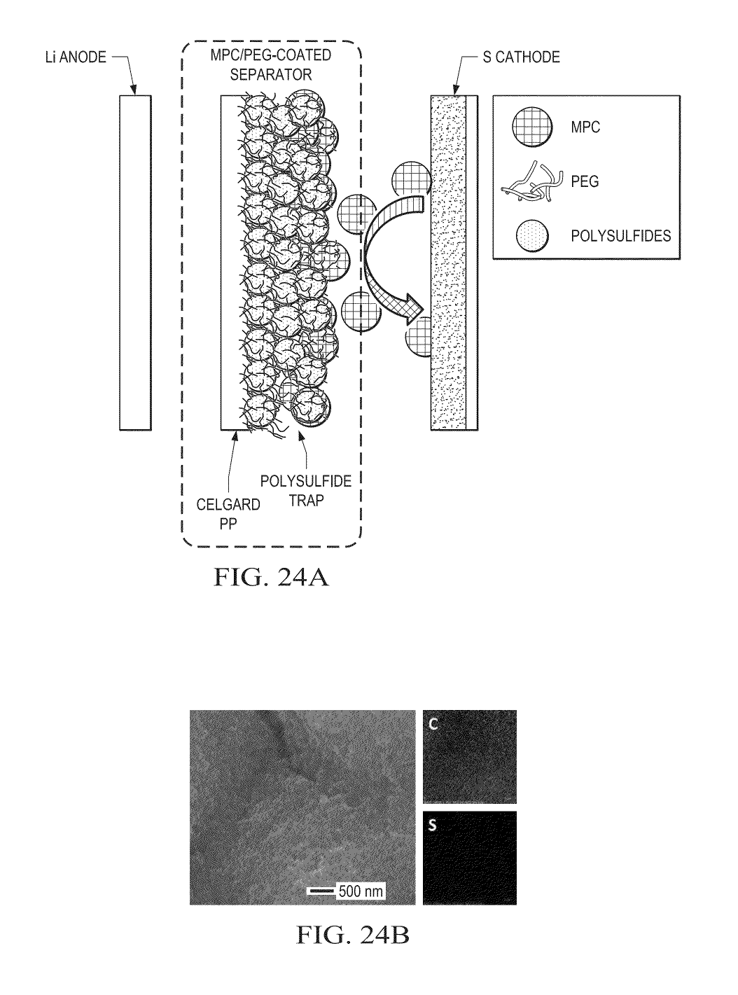

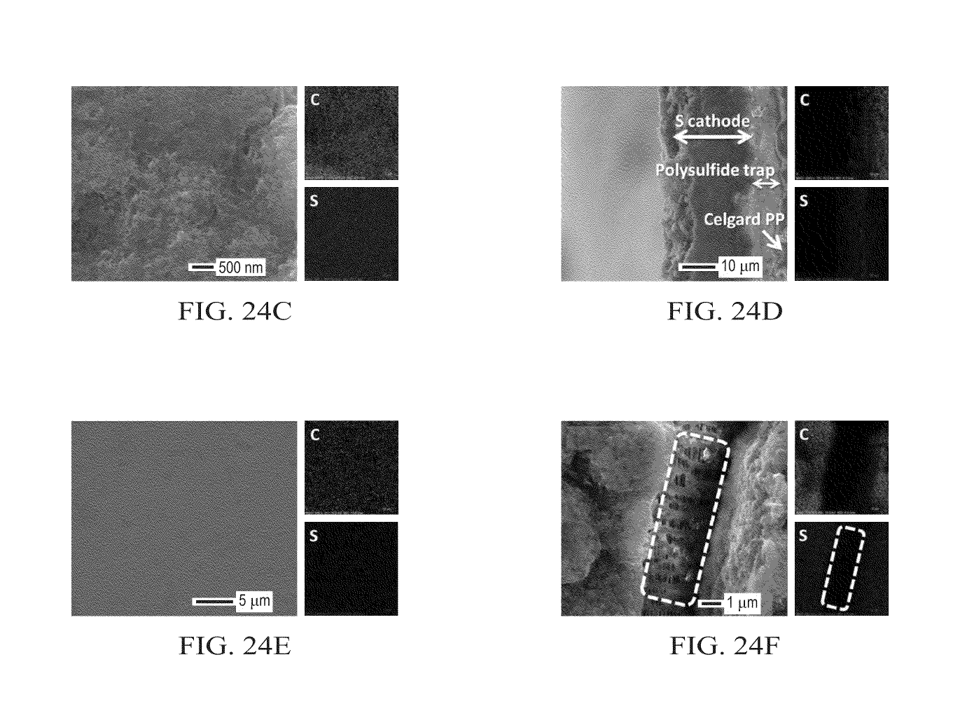

An exemplary cell having a bifunctional separator with a polymer-coated microporous carbon layer is illustrated schematically in FIG. 24A. The MPC/PEG coating side of the composite separator faces the sulfur cathode to intercept the migrating polysulfides before they diffuse to the Celgard PP and function as an upper current collector to facilitate electron transport for enhancing the electrochemical utilization of sulfur and for reactivating the trapped active material.

The morphology of the MPC/PEG layer surface is shown in FIG. 24B. The microporous carbon is distributed in clusters attached to the electrically insulative layer of the bifunctional separator. SEM micrographs and corresponding elemental mapping of the surface of the MPC/PEG layer facing the cathode after cycling are provided in FIG. 24C. Active sulfur cathode material (shown in red) is evenly distributed in the MPC/PEG coating layer with no apparent dense spots.

SEM micrographs and corresponding elemental mapping of a cross-section of a cycled cell containing the MPC/PEG layer are provided in FIG. 24D. The sulfur cathode exhibits uniform sulfur signal with no agglomeration or loss of the active cathode material. The MPC/PEG layer of the bifunctional separator exhibits strong sulfur signal, indicating interception of migrating polysulfides by the MPC/PEG layer. A gradient of sulfur signal is evident in the MPC/PEG later, with weak sulfur signal observed toward the Celgard layer of the separator.

SEM micrographs of the surface of the Celgard layer and the Celgard-facing surface of the MPC/PEG layer of the bifunctional separator are provided in FIGS. 24E and 24F. Very low sulfur signal is apparent, indicating that the diffusing polysulfides are effectively trapped by the MPC/PEG layer.

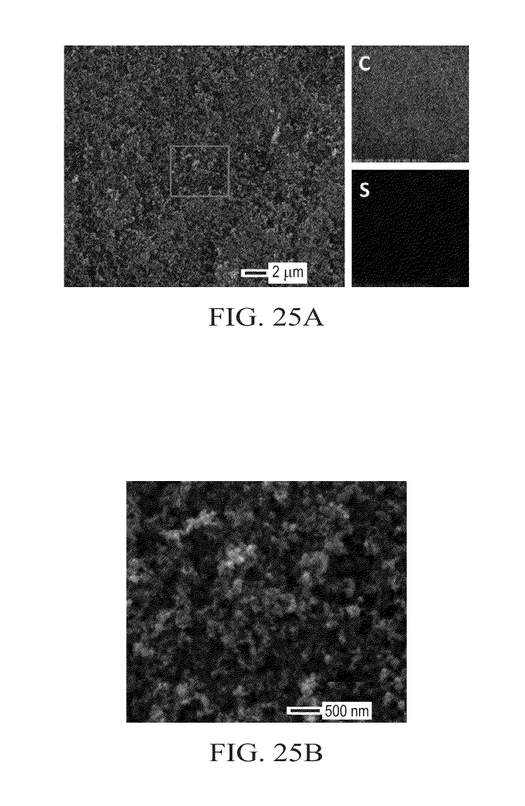

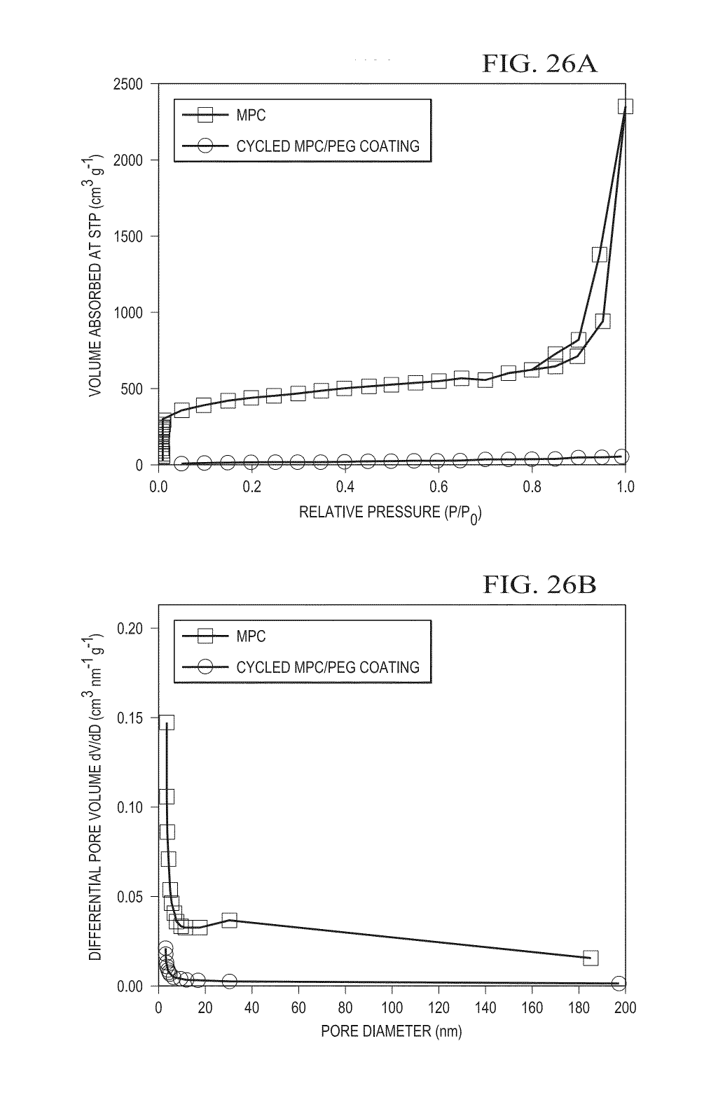

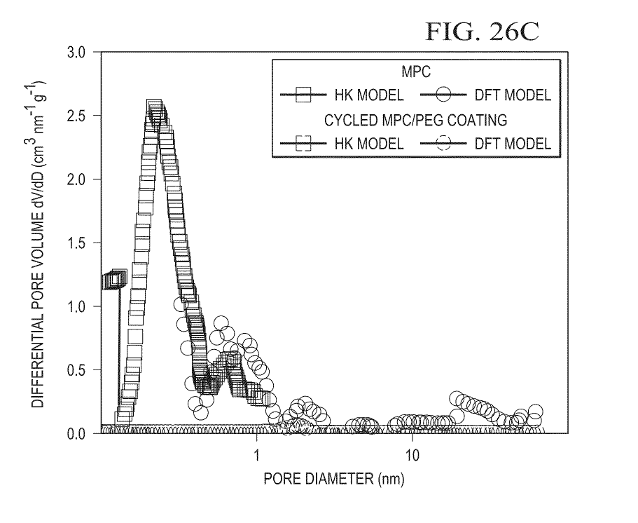

Additional high-magnification SEM micrographs of the MPC/PEG layer are provided in FIGS. 25A and 25B. The MPC/PEG layer is highly microporous as shown. Surface area analyses of the MPC/PEG coating layer in uncycled and cycled cells, as determined by isotherms, pore size distributions with the Barrett-Joyer-Halenda (BJH) method, and pore size distributions with the Horvath-Kawazoe and density functional theory methods, are shown in FIGS. 26A-C, respectively. The IUPAC type I isotherms and the high fraction of micropores demonstrate that MPCs have a high surface area, large porous space, and high microporosity. After cycling, the decrease in the surface area and microporous trapping sites suggests efficient trapping by the MPC/PEG coating layer of the cycled cathode products. In FIG. 26B, the BJH model is used for analyzing a broad pore size distribution. In FIG. 26C, the HK model displays the micropore filling behavior and the DFT model summarizes the adsorption characterization of micro/mesopores. The surface area of the MPC/PEG layer in uncycled cells as determined by BET analysis is 1321 m² g⁻¹, with a pore volume of 3.62 cm³ g⁻¹, and a micropore volume of 0.65 cm3 g-1. After the electrochemical cycling, the surface area of the MPC/PEG coating is decreased to 49 m² g⁻¹, the pore volume is lowered to 0.09 cm³ g⁻¹, and the micropore volume lowered to 0.0.1 cm3 g⁻¹.

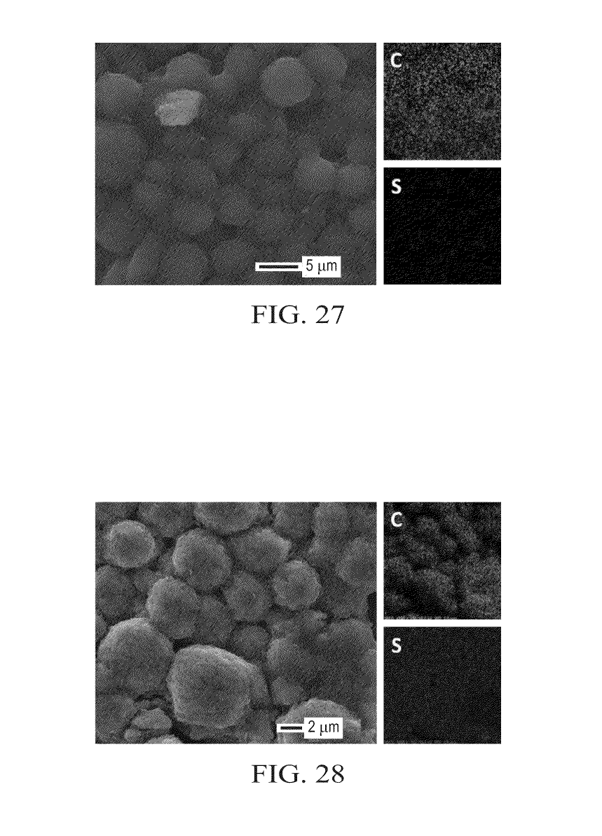

High magnification SEM micrographs of the surface of the MPC/PEG layer surface of the bifunctional separator and corresponding elemental signal maps from uncycled and cycled cells are provided in FIG. 27 and FIG. 28, respectively. In contrast to the uncycled separator, the cycled separator exhibits obvious morphological and elemental changes, with trapped active sulfur material uniformly distributed on the MPC-PEG layer surface. Elemental carbon signals are distinguishable from the elemental sulfur signals.

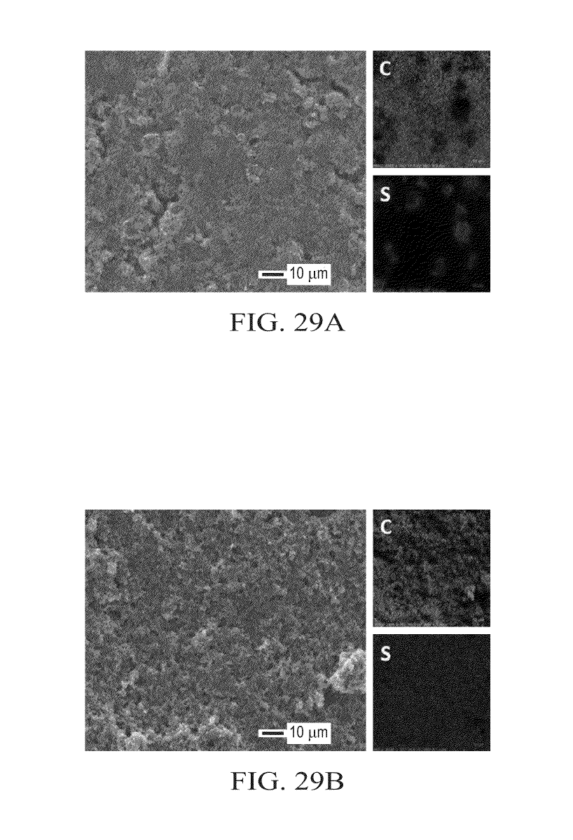

SEM micrographs, with corresponding elemental mapping, of a pure sulfur cathode from an uncycled cell and a cycled cell containing an MPC/PEG layer-containing separator are shown in FIGS. 29A and 29B, respectively. The fresh cathode shows several micron-sized sulfur agglomerations surrounded by Super P carbon. After cycling, the rearranged active material displays a uniform distribution. The corresponding elemental sulfur signals show neither dense spots nor vacancies in the cycled cathode, implying an optimized electrochemical environment with no active material loss.

Electrochemical Analysis

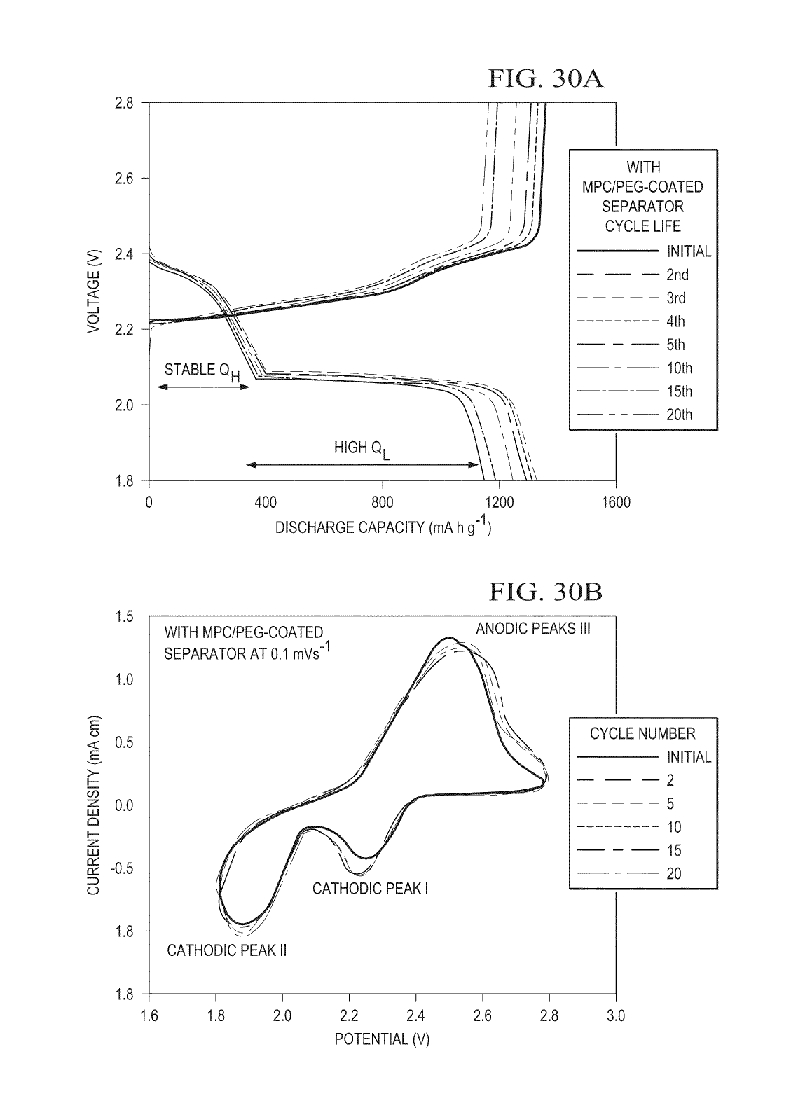

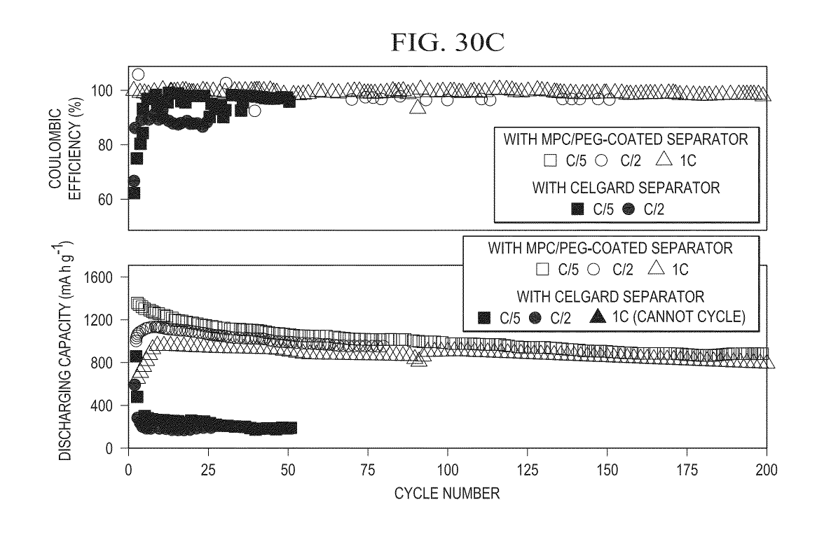

FIG. 30A shows the discharge/charge curves for cycles 1-5, 10, 15 and 20 of the cells utilizing the MPC/PEG-coated separator at a C/5 rate. During cell discharge, the upper discharge plateau at 2.3 V indicates the reduction reaction from sulfur to long-chain polysulfides (Li₂Sₓ, 4<x≦8). The lower discharge plateau at 2.1 V represents the transformation of long-chain polysulfides to Li₂S₂/Li₂S. During cell charge, the two continuous charge plateaus at 2.2 and 2.4 V correspond to the oxidation reactions of Li₂S₂/Li₂S to Li₂S₈/S. The overlapping upper discharge plateaus are well-retained, indicating limited polysulfide diffusion and almost no active material loss. The overlapping discharge curves, on the other hand, demonstrate that the MPC/PEG coating continuously reactivates the trapped active material, attesting to the high electrochemical reversibility and stability of the cell.

Cyclic voltammograms of the cell containing the bifunctional separator having an MPC/PEG layer for cycles 1, 2, 5, 10, 15, and 20 at a scanning rate of 0.1 mVs⁻¹ are shown in FIG. 30B. The cyclic voltammograms display the typical two-step reduction reactions (cathodic peak I and II) in the cathodic sweep and two overlapping oxidation reactions (anodic peaks III) in the anodic sweep, consistent with the discharge/charge curves depicted in FIG. 30A. The cathodic and anodic peaks maintain almost the same magnitude and show no severe potential shifts.

Discharge capacity and Coulombic efficiency data at cycling rates of C/5, C/2, or 1C for cells containing the MPC-PEG-coated separator or a conventional Celgard separator are shown in FIG. 30C. Cells containing an MPC/PEG-coated separator and a pure sulfur cathode containing 70 wt. % sulfur exhibit high discharge capacities, stable cyclability, and good rate performance. After upgrading the Celgard separator to the MPC/PEG-coated separator, the initial discharge capacities (with sulfur utilization in parentheses) increase from 843 (50%) to 1307 mA h g⁻¹ (78%) and from 543 (32%) to 1018 mA h g⁻¹ (61%) at, respectively, C/5 and C/2 rates. At a 1C rate, the MPC/PEG-coated separator allows the pure sulfur cathode to function normally by offering efficient electron conduction and fast ion transport through the conductive and porous MPC/PEG coating. A capacity increase is observed during the initial 10 cycles at various C rates, due, it is believed, to the rearrangement of the active material as it conditions itself to occupy the more electrochemically favorable positions. Without limitation to theory, it is believed that the rearranged active material may be (i) surrounded by conductive carbon and stabilized in the cathode or (ii) immobilized in the conductive polysulfide trap. In the sequent cycles, the conductive/porous MPC/PEG coating transfers electrons, charges, and liquid electrolyte to reactivate the trapped cycled products to exhibit efficient reutilization of the trapped active material and high reversibility. Therefore, after 200 cycles, the discharge capacities of the cells employing the MPC/PEG-coated separator are 839, 795, and 782 mA h g⁻¹ at, respectively, C/5, C/2, and 1C rates. The composite separator greatly lowers the capacity fading to 0.18% (at a C/5 rate), 0.11% (at a C/2 rate), and 0.08% (at a 1C rate) per cycle. After 500 cycles, the reversible capacity of cells containing the MPC/PEG-coated separator approaches 600 mA h g⁻¹, with a corresponding capacity fade of only 0.11% per cycle.

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount. Additionally, one of ordinary skill in the art will appreciate that a cathode containing MWCNT and catholyte or microparticles as described herein or a cathode/catholyte combination may be prepared in accordance with the present disclosure independently from the anode. Such cathodes or cathode/catholyte combinations would clearly be intended for use in batteries of the present disclosure.

1. A separator for an electrochemical cell, the separator comprising:
an electrically insulating layer; and
a layer of microporous, conductive material deposited on the electrically insulating layer.

2. The separator of claim 1, wherein the microporous conductive material comprises carbon.

3. The separator of claim 2, wherein the microporous conductive material comprises carbon powder.

4. The separator of claim 2, wherein the microporous conductive material comprises carbon nanotubes.

5. The separator of claim 4, wherein the carbon nanotubes are interwoven.

6. The separator of claim 4, wherein the carbon nanotubes comprise multi-walled carbon nanotubes.

7. The separator of claim 2, wherein the microporous conductive material comprises polyethylene glycol-coated microporous carbon powder.

8. The separator of claim 1 preceding claims, wherein the layer of microporous carbon material has a weight of less than about 0.2 mg cm⁻².

9. The separator of any claim 1, wherein the layer of microporous carbon material has a thickness of between about 2 μm and about 30 μm.

10. The separator of claim 1, wherein the electrically insulating layer is microporous polypropylene having a thickness of about 20 μm to about 30 μm.

11. A lithium-sulfur battery comprising:
an anode comprising lithium;
at least one of a cathode comprising electroactive sulfur and a catholyte comprising electroactive sulfur; and
a separator according to any of claims 1-10.

12. The battery of claim 11, wherein the total content of electroactive sulfur of the cell is about 60% or more by weight.

13. The battery of claim 11, wherein the initial discharge capacity of the cell is about 1300 mA hg⁻¹ or greater at a cycling rate of C/5.

14. The electrochemical cell of claim 11, wherein the capacity fade of the cells is less than about 0.2% per cycle after 200 cycles.

15. The battery of claim 11, wherein the layer of microporous, conductive material faces the cathode and the electrically insulative layer faces the anode.
